(19) United States
(12) Patent Application Publication
(10) Pub. No.: US 2015/0088847 A1
(43) Pub. Date: Mar. 26, 2015

(54) METHOD OF DISPLAYING A CUSTOMIZED ADDRESS BAR OR SEARCH RESULTS IN A BROWSER

(71) Applicant: ICON IP TECHNOLOGIES PTY LTD, South Yarra, Victoria (AU)

(72) Inventor: Paul Damian Nelson, South Yarra (AU)

(73) Assignee: ICON IP TECHNOLOGIES PTY LTD, South Yarra, Victoria (AU)

(21) Appl. No.: 14/399,859

(22) PCT Filed: May 8, 2013
(86) PCT No.: PCT/AU2013/000471

§ 371 Date: Nov. 7, 2014

(30) Foreign Application Priority Data
May 9, 2012 (AU) 2012901893
Jun. 29, 2012 (AU) 2012902803

(51) Int. Cl. G06F 17/30

(52) U.S. Cl. CPC G06F 17/30867
USPC 707/706

(57) ABSTRACT

Disclosed is a method of displaying a customised location bar or tab in a browser comprising: sending a request for content from a browser to a web server associated with a uniform resource locator (URL) entered into the browser; receiving the requested content from the web server at the browser; sending a request for custom domain data from the browser to a domain registration service, the request for custom domain data comprising information indicative of at least a portion of the URL; receiving custom domain data from the domain registration service at the browser if at least a portion of the URL is registered with the domain registration service; and controlling the appearance of the contents of the location bar or tab in accordance with the received custom domain data. A method for similarly displaying customised search results and associated systems are also disclosed.

### FIELD OF THE INVENTION

The present invention is generally related to the displaying of content in a web browser and particularly, although not exclusively, related to the displaying of customised content in a web browser as may be desired by a website manager or owner.

### RELATED APPLICATION

This application is related to Australian provisional patent applications 2012901893 and 2012902803, the contents of which are incorporated entirely herein by reference.

### BACKGROUND TO THE INVENTION

A web browser is a software application which may be used for requesting, accessing, retrieving, presenting, displaying viewing or navigating through information, such as websites or web pages, images, video and other content on the internet. The primary purpose of a web browser may therefore be the provision or display of information to a user.

The address bar or location bar is a content field (which may display symbols such as alphanumeric characters) usually located towards the top of a web browser window. The location bar may display the URL (which typically comprises a domaia name) of a website or webpage being viewed by a user. The locatign bar may allow a user to manually type the URL of a website they wish to view.

The URL displayed in the location bar may therefore reflect the address of the current page or website being viewed on the web browser and may automatically update whenever a user visits or navigates to a new webpage or website, which may allow a user to determine the location or URL of the webpage currently being displayed or viewed.

A web browser may allow the display of a favicon directly to the left of the URL in the location bar. The favicon may provide a visual identifier for a website and may allow the owner, manager, administrator or controller of a URL, domain name, or website to provide some additional aesthetic element to the location bar or URL.

A web search engine may be a website designed to allow a user to search for information on the internet. Typically, a user will enter a search term or search query into the search engine space line or text field (which may be defined as the space within which a user can enter text such as a search query). Alternatively, a user may enter a search query into a search engine toolbar provided in the browser graphical user interface (GUI). A search engine toolbar is typically arranged to pass a search query directly from the browser to a chosen or default search engine. Some browsers may combine the location bar and search engine toolbar. The search engine may use the received search query to search available or indexed web pages, images, information or other files such as available databases and directories. The search engine may then compile the results and display them as a list of search results based upon the relevance of the content of each result when compared to the search query.

### SUMMARY OF THE INVENTION

In a first aspect the invention broadly comprises a method of displaying a customised location bar or tab in a browser comprising:
sending a request for content from a browser to a web server associated with a uniform resource locator (URL) entered into the browser;
receiving the requested content from the web server at the browser;
sending a request for custom domain data from the browser to a domain registration service, the request for custom domain data comprising information indicative of at least a portion of the URL;
receiving custom domain data from the domain registration service at the browser if at least a portion of the URL is registered with the domain registration service; and
controlling the appearance of the contents of the location bar or tab in accordance with the received custom domain data.

In an embodiment, the information indicative of the URL is a domain name and custom domain data is received if the domain name is registered with the domain registration service.

In an embodiment, the received custom domain data comprises different items of custom domain data corresponding to the same domain name, and where the browser controls the appearance of the contents of the location bar or tab according to the custom domain data corresponding with the displayed URL.

In an embodiment, the method comprises receiving a negative response from the domain registration service at the browser if the URL is not registered with the domain registration service.

In an embodiment, the method comprises displaying the requested content in the browser after receiving the custom domain data at the browser.

In an embodiment, the method comprises displaying an interface in the browser, the interface arranged to allow a website manager to modify the controlled appearance of the location bar.

In a second aspect the invention broadly comprises a method of displaying a customised search result from a search engine comprising:
sending a search query from a browser to a search engine;
receiving the search query at the search engine and generating information indicative of one or more search results based on the search query where each search result is associated with a uniform resource locator (URL);
sending a request for custom domain data from the search engine to a domain registration service, the request for custom domain data comprising information indicative of at least a portion of each of the one or more URLs;
receiving custom domain data from the domain registration service at the search engine for each URL registered with the domain registration service;
receiving the information indicative of the one or more search results and the custom domain data from the search engine at the web browser; and
displaying the search results in the browser such that the appearance of each search result with corresponding custom domain data is controlled in accordance with the custom domain data.

In an embodiment, the information indicative of the URL is a domain name and custom domain data is received if the domain name is registered with the domain registration service.

In an embodiment, the received custom domain data comprises different items of custom domain data corresponding to the same domain name, and where the browser controls the appearance of the search results according to the custom domain data corresponding with the URL of the displayed search result.

In an embodiment, the search engine is arranged to send a request for content to a web server; receive content from the web server, and send the content to the browser.

In an embodiment, the method comprises receiving a negative response from the domain registration service at the search engine if none of the URLs are registered with the registration service.

In an embodiment, the method comprises displaying an interface in the browser, the interface arranged to allow a website manager to modify the controlled appearance of a search result.

In a third aspect the invention broadly comprises computer program code which when executed implements the method of any one of the embodiments above.

In a fourth aspect the invention broadly comprises a computer readable medium comprising the computer program code of the third aspect.

In a fifth aspect the invention broadly comprises a domain registration service comprising:
a database of custom domain data indexed by at least portions of uniform resource locators (URLs) wherein for at least some of the URLs the database of custom domain data comprises different items of custom domain data;
the domain registration service being arranged to receive a request for custom domain data from a requesting entity comprising information indicative of at least a portion of a URL, search the database of custom domain data based on the received information indicative of a URL, and send any located custom domain data to the requesting entity,
whereby the domain registration service returns different custom domain data related to the same domain name depending on the URL of the request.

In an embodiment, the at least a portion of a URL comprises a domain name.

In an embodiment, the request for custom domain data comprises the URL, and where the domain registration service is arranged to extract at least one portion from the URL to search the database.

In a sixth aspect the invention broadly comprises a computer-based system comprising:
a domain registration service;
a browser comprising a location bar or tab and being arranged to send a request for content to and receive content from a web server associated with a uniform resource locator (URL), send a request for custom domain data comprising information indicative of at least a portion of the URL to a domain registration service, receive custom domain data from the domain registration service, display content received from the web server, and control the appearance of the location bar or tab in accordance with the custom domain data from the domain registration service;
the domain registration service comprising a database custom domain data indexed by at least a portion of a URL and being arranged to receive from the browser a request for custom domain data comprising information indicative of at least a portion of a URL, search the database of custom domain data based on the received information indicative of a URL, and send to the browser any located custom domain data.

In an embodiment, the computer-based system comprises a web server associated with a URL and being arranged to host content associated with a website associated with the URL, and to receive the request for content from and send content to the browser.

In an embodiment, the information indicative of the URL is a domain name and custom domain data is received if the domain name is registered with the domain registration service.

In an embodiment, the received custom domain data comprises different items of custom domain data corresponding to the same domain name, and where the browser controls the appearance of the contents of the location bar or tab according to the custom domain data corresponding with the displayed URL.

In an embodiment, the domain registration service is arranged to send a negative response to the browser if the URL is not registered with the domain registration service.

In an embodiment, the computer-based system is arranged to display the requested content in the browser after receiving the custom domain data at the browser.

In an embodiment, the browser is arranged to display an interface arranged to allow a website manager to modify the controlled appearance of the location bar.

In a seventh aspect the invention broadly comprises a computer-based system comprising:
a domain registration service;
a browser arranged to send a search query to a search engine, receive information indicative of one or more search results and custom domain data corresponding to the one or more search results from the search engine, and display the search results such that the appearance of each search result with corresponding custom domain data is controlled in accordance with the custom domain data;
the domain registration service comprising a database of custom domain data indexed by at least a portion of a uniform resource locator (URL) and being arranged to receive a request for custom domain data from the search engine comprising information indicative of at least a portion of a URL, search the database of custom domain data based on the received information indicative of a URL, and send any located custom domain data to the search engine.

In an embodiment, the computer-based system comprises a search engine arranged to receive the search query from the browser, generate information indicative of one or more search results based on the search query where each search result is associated with a URL, send a request for custom domain data comprising information indicative of at least a portion of each of the one or more URLs to the domain registration service, receive custom domain data from the domain registration service, and send the information indicative of the one or more search results and corresponding custom domain data to the browser.

In an embodiment, the information indicative of the URL is a domain name and custom domain data is received if the domain name is registered with the domain registration service.

In an embodiment, the received custom domain data comprises different items of custom domain data corresponding to the same domain name, and where the browser controls the appearance of the search results according to the custom domain data corresponding with the URL of the displayed search result.

In an embodiment, the search engine is arranged to send a request for content to a web server, receive content from the web server, and send the content to the browser.

In an embodiment, the domain registration service is arranged to send a negative response to the browser if the domain name is not registered with the domain registration service.

In an embodiment, the browser is arranged to display an interface arranged to allow a website manager to modify the controlled appearance of the location bar.

In an eighth aspect the invention broadly comprises a domain registration service comprising a database comprising custom domain data indexed by at least portions of uniform resource locators (URLs), wherein the domain registration service is arranged to receive from a browser a request for custom domain data comprising information indicative of at least a portion of a URL and, upon determining that custom domain data corresponding to the received information is stored in the database, send the corresponding custom domain data to the browser for controlling the appearance of the contents of a location bar or tab.

In a ninth aspect the invention broadly comprises a domain registration service comprising a database comprising custom domain data indexed by at least portions of uniform resource locators (URLs), wherein the domain registration service is arranged to receive from a search engine a request for custom domain data comprising information indicative of at least a portion of a URL for each of one or more search results generated by the search engine and, upon determining that custom domain data corresponding to one or more of the URLs indicated in the received information is stored in the database, send the custom domain data corresponding to the one or more URLs to the search engine for controlling the appearance of the search results.

### BRIEF DESCRIPTION OF THE DRAWINGS

An embodiment, incorporating all aspects of the invention, will now be described by way of example only with reference to the accompanying Figures in which:

FIG. 1a is a standard representation of a domain name and URL as displayed in a location bar:

FIGS. 1b-d are examples of alternate representations of domain names and URLs as displayed in a location bar;

FIGS. 2a-d are examples of alternate representations of domain names and URLs as displayed in a location bar;

FIGS. 3a-c are examples of alternate representations of domain names and URLs as displayed in a location bar;

FIG. 3d is an example of alternate representations of the content of a tab as displayed by a browser.

FIG. 4 is a view of different states of interactive digital media;

FIG. 5 is a view of two states of interactive digital media;

FIGS. 6a-e are examples of alternate representations of domain names and URLs as displayed in a location bar;

FIG. 7 is an example search result;

FIG. 8 is the search result of FIG. 7 comprising digital media above;

FIG. 9 is the search result of FIG. 7 comprising digital media to the left;

FIG. 10 is an example search result comprising digital media to the left;

FIG. 11 is a flow chart of a method of display digital media in relation to a search result;

FIG. 12 is a view of a browser displaying digital media to the left of a search result;

FIGS. 13-15 show a view of sequentially animated digital media displayed to the left of a search result;

FIG. 16 is a view of a browser displaying digital media between the heading and extract of a search result;

FIGS. 17-18 show a view of sequentially animated digital media displayed between the heading and extract of a search result;

FIG. 19 is a view of a browser displaying digital media laid under or over a search result;

FIGS. 20-21 show a view of sequentially animated digital media in the place of a search result;

FIG. 22 is a view of a browser showing digital media, a search result, and a word indicating an “Ad”;

FIGS. 23-26 show a view of sequentially animated digital media displayed in relation to a search result, and a word indicating an “Ad”;

FIG. 27 shows a search result and “Show Ad” button displayed on a small screen client;

FIG. 28 shows the display of the small screen client of FIG. 27 after the “Show Ad” button has been pressed;

FIGS. 29-31 show a view of sequentially animated digital media displayed on a browser of a small screen client;

FIG. 32 is a search engine displayed in a browser;

FIG. 33 shows website source code displayed in a browser;

FIG. 34 is a preview of a custom search result;

FIG. 35 is a preview of a different custom search result;

FIG. 36 is a list of search results displayed in a browser including a custom search result;

FIG. 37 shows an interface displaying websites registered with a domain registration service;

FIG. 38 shows a flow chart of an embodiment;

FIG. 39 shows a domain name and URL displayed in a location bar of a browser;

FIG. 40 shows a search result displayed in a browser;

FIG. 41 shows a custom domain name and URL displayed in a location bar of a browser;

FIG. 41a shows a domain name and URL comprising additional information;

FIG. 42 shows a schematic of an embodiment of the invention comprising a domain registration service and browser;

FIG. 43 shows a schematic of an embodiment of displaying content in a browser and a custom location bar in the browser; and

FIG. 44 shows a schematic of an embodiment of displaying custom search results in a browser.

### DETAILED DESCRIPTION OF EMBODIMENTS OF THE INVENTION

The invention is generally related to a method of displaying customised font or a Customised image or images in a web browser, for example, in an address bar or tab of the browser or in a list of search results displayed by the browser.

The term “font”, and related terms such as “fonts”, as used in this specification and claims typically refers to a computer font or file with font that can be embedded into at least part of a webpage. A font may provide a resource or file containing a visual representation of characters and may comprise information that maps character codes to shapes or glyphs that represent such characters. Fonts sharing a common design style may be grouped into font families classified by a set of standard font properties. Within such a family, the shape displayed fora given character can vary by stroke weight, slant, relative width, or other aspects, properties or characteristics. A font may be described by a unique combination of such aspects, properties or characteristics. A font may comprise a bitmap font format, an outline font, a stroke-based font, or any other suitable font system employed or used by a web browser or search engine. Additionally, fonts may include or be serif, sans-serif, monospaced, script, blackletter, non-latin (for example, non-english language based fonts such as a Japanese font), unicode, dingbat or symbol-based fonts, display or decorative fonts, simulation or mimicry fonts, or any other suitable font system, or anything uploaded to or read by a client to be used as a chosen font.

In some embodiments, a web browser or search engine may be controlled to display to a user a URL, location bar, tab or one or more search engine results in a manner or style that may be desired by the website or domain name owner, manager, administrator or controller. This may provide, for example, branding or a look and feel of a location bar, tab or search result that is consistent with, for example, a branding scheme, or is at least desired by the website manager.

Customising the appearance of a search result associated with a website manager's domain name may help visually differentiate that search result from other, unrelated search results. For example, a user may input the search query “coca cola” to a search engine which then returns a list of relevant hits. The user may then need to read text associated with each search result in order to identify what they may be looking for. A customised search result comprising, for example, imagery or advertising may be more effective than text alone (which can be very limiting in impact). Such a customised search result may help a user more easily find a more relevant or official website.

Further, some embodiments may provide for more effective or efficient use of space on a website such as a search engine. A user may perform a search at a search engine, for example for “coca cola”, resulting in the display of one or more text-based search results. The text-based search results may be displayed, for example, in a list that is aligned to the left of the webpage as displayed on the browser. As such, there may be unused space on the right of the webpage. The display of the text alone may not be as effective as imagery, and so the text shown may be limiting in impact and, consequentially, the search results may be difficult for a user to browse or scan.

In Australian patent application 2012901893, the term “medium” was used to describe the representation or visual display of information or material such as on a website, visual display resulting from software or programs in a machine readable form executing the current invention on a computer, mobile telephone or other such electronic device physical print, or any other representation of same. In this specification and the claims, the term “client” or variations such as “clients” incorporate the term “medium” as defined above and as defined in Australian patent application 2012901893, in addition to any electronic device which is arranged to communicate over a network, such as the internet, and is further arranged to display a website, for example on a browser, such as a computer, tablet, mobile phone, handheld gaming device, personal digital assistant (FDA), television or any other suitable device.

In some embodiments, the appearance of the location bar, domain name, tab or URL may be updated, confirmed or controlled to change by the web browser. When the appearance of the location bar, domain name or URL is updated, confirmed or controlled to change, a customised or registered font may be applied, or for example, an image file embedded, to either the domain portion or the entire displayed URL.

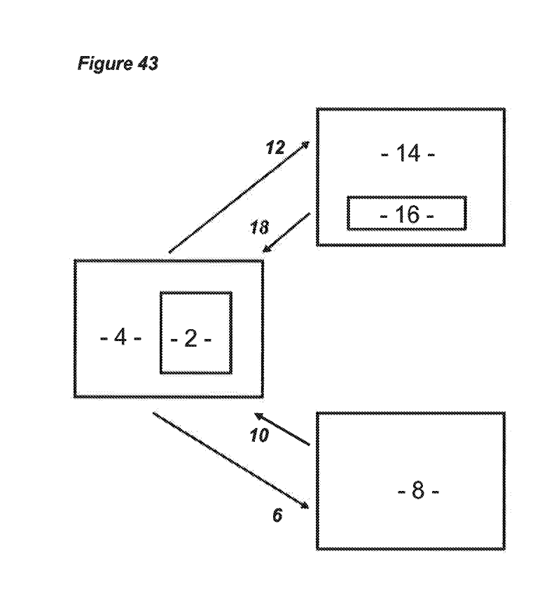

Referring to FIG. 43, in some embodiments, the following method (not necessarily in this order) may be used to control, customise or update the appearance of a domain name, URL, tab or location bar:
a browser 2 running on a client 4 may send 6 a request for content to a web server 8 which hosts content associated with a website or domain name;
the browser 2 may receive 10 content from the web server 8;
prior to, contemporaneously, concurrently with, or subsequent to displaying the requested content, the browser 2 sends 12 a request for custom domain data to a domain registration service 14, where the request 12 for custom domain data typically comprises information or data pertaining to or indicative of the URL or domain name of the website;
the domain registration service 14 may check the URL or domain name against one or more databases 16 which include custom fonts, layouts, designs, or any other files associated with the URL, domain name or website;
in the event that the domain registration service 14 contains no record of the domain name, or at least part of the URL or website, the domain registration service 14 may send 18 a negative response which is received by the browser 2 and the URL may be displayed in the default font used by the web browser on the user's client 4; and
if the domain registration service 14 comprises a record of the domain name, or at least part of the URL or website, the domain registration service 14 may send 18 the custom font, layout, design, or file or custom domain data which is received by the browser 2 and which may be displayed in the location bar or tab.

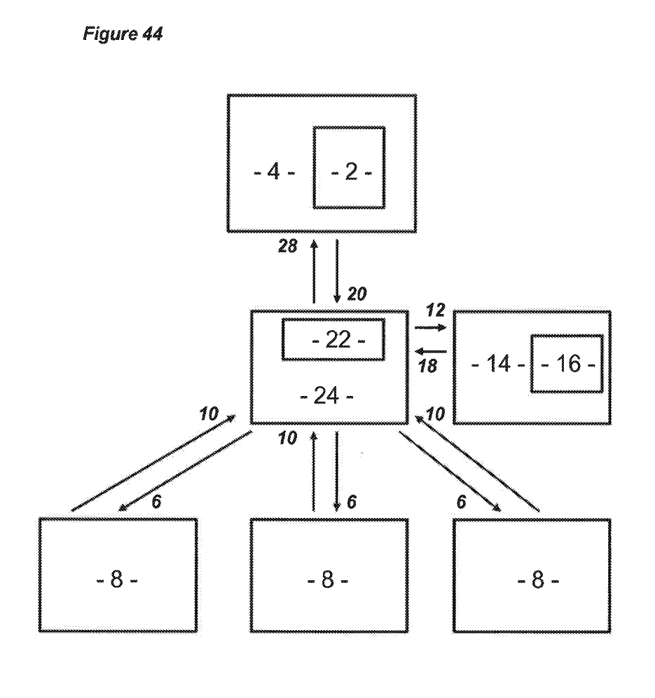

Referring to FIG. 44, a user may perform a search at a search engine by, for example, entering a query into a search engine website or search engine toolbar provided on a browser 2 (by inputting content such as keywords). The search engine typically reviews its database or index of websites and provides a listing of relevant, best-matching or most appropriate webpages or websites according to its criteria. This may be accompanied by a short summary containing the website's or document's title and extracts of the text from the website or document itself, and may optionally include thumbnail of a webpage or document.

In some embodiments, one or more search engine results within a list of results may be customised such that they are displayed to a user in a manner desired by a website manager. The displayed URL, domain name, title, summary, extract, description, content or any other suitable part of the displayed search result may be displayed in a customised manner. The following method (not necessarily in this order) may be used to control, customise or update the appearance of one or more search results to be displayed in a list of search results as returned by a search engine:
a web browser 2 running on a client 4 may send 20 a search query or request to a search engine 22 which may be hosted on a search engine server 24;
the search engine 22 may generate one or more search results or information indicative of one or more search results based on the received search query;
the search engine 22 may send 6 a request for content to the one or more websites identified in its search results. In doing so, the search engine 22 may contact a website server and request or obtain data. Typically the search engine 22 contacts a website via a web server that hosts the website or content;
the search engine 22 may receive 10 content or data from one or more websites;
prior to, contemporaneously or concurrently with, or subsequent to displaying the requested search results, the search engine 22 may compile relevant search results and send a request 12 for custom domain data to the domain registration service 14. The request 12 for custom domain data typically comprises information or data pertaining to one or more of the URLs or domain names associated with the search results;
the domain registration service 14 may check the URL or domain name against one or more databases 16 which includes custom fonts, layouts, designs, or any other files associated with the URL, domain name or website;
in the event that the domain registration service 14 contains no record of a domain name, or at least part of the URL or website, the domain registration service 14 may send 18 a negative response which is received by the search engine 22, and the search result may be displayed in the default font used by the search engine 22;
if the domain registration service 14 comprises a record of the domain name, URL or website, the domain registration service 14 may send 18 the custom font or file or custom domain data which is received by the search engine 22; and
the search engine 22 may send 28 the custom search results to the client 4 or browser 2 for customised display to the user if there is registered custom domain data. Alternatively, the search engine 22 may send non-custom search results to the client or browser 2 for display if there is no registered custom domain data.

In some embodiments, the search engine 22 may compile its list of search results prior to the display of those search results. In such embodiments, the search engine 22 may subsequently send 12 a request for custom domain data to the domain registration service 14. The domain registration service 14 may then determine if the requested domain name, URL or website is registered and has corresponding custom domain data, such as a font or file or other material, to embed within the search results. If the domain registration service 14 does not comprise the received domain name, URL or website on its database 16, it may provide a negative response in which case the search results corresponding to that domain name, URL or website will be displayed in its standard default font or format. If the domain registration service 14 comprises the requested domain name, URL or website on its database 16, it may provide a positive response and may provide the corresponding custom font or other material to be displayed or one or more files to embed. The search engine 22 may then display one or more customised search results or a customised field line or both as specified by the URL, domain name or website manager or owner.

In some embodiments, the interface or display of a medium or client 4 which has access to the internet, websites or URL, or search engines may be used.

In some embodiments, a method or process of the invention may be executed by a system such as a computer system, software or a program such as a browser 2 or an application, or a client 4 or medium such as any product that can access the internet, including a computer, or mobile telephone. The domain name, URL or website as displayed in the location bar may be in the form of a web site domain address, wherein the address and field for the address can be different to what is currently on the market and whereby the difference can include any field size or type, font colour, type or size, black or white, or any combination or permutation of same. Alternatively or additionally, block colours or shapes comprising colour may be used in conjunction with a domain name or names. Similarly, the text or favicon or both as displayed on a tab of a browser can be different to what is currently on the market and whereby the difference can include any field size or type, font colour, type or size, black or white, or any combination or permutation of same.

Any suitable font may be used in the display of domain names and tabs.

A suitable image such as a trade mark or service mark may be used in relation to the domain name or URL as displayed in a location bar, or as displayed in a tab.

Digital media may be interactive in any suitable manner.

Any suitable host, prefix or suffix may be used in relation to the display of a domain name or URL in a location bar.

Alternatively, no host prefix or suffix may be used.

Some embodiments may relate to a method or process of communication via advertising on a webpage or browser, comprising:
a method of showing or displaying an advertisement within a search result which begins when the user of a search engine submitting a search term request. The associated or corresponding domain name or URL of each search result may be used to request custom domain data from a domain registration service.
an internet advertising bureau (IAB) standard medium rectangle display advertisement may be displayed in proximity to a search result listing. This placeholder may be displayed as interactive media (for example, Adobe Flash, HTML5, animated GIF, or any other suitable interactive digital media) and may be able to link to a different URL than the search result.
displayed advertisements may not necessarily be restricted to a single IAB ad size and may also be non-interactive media, for example, a single frame image format.
displayed advertisements may not necessarily adhere to IAB standards. The displayed advertisements themselves may incorporate elements of, or the entire search result listing.

Some embodiments of the invention will be described by way of example to the accompanying figures.

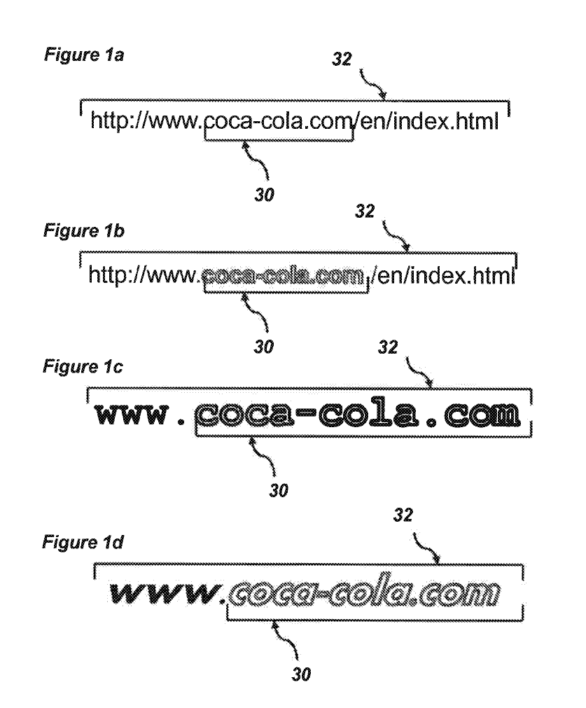

Referring to FIGS. 1a-d, examples of domain names 30 and URLs 32 are shown. Referring to FIG. 1a, a standard domain name 30 and URL 32, as may be displayed in a location bar or in relation to a search result, may comprise a standard or traditional font, such as Arial, and may be coloured black. The traditional domain name 30 and URL 32 may be displayed in a location bar of a browser or search results of a search engine as displayed in a browser. Referring to FIG. 1b, the same domain name 30 and URL may be displayed in a location bar or in relation to search results with a portion in a non-standard colour, such as red, to emphasize, for example, trade mark or brand. A tab may be controlled to display text or an image in a similar manner. A coloured portion of a domain name 30 or URL 32 is represented in the drawings by-outline only characters as per the string “coca-cola” in FIG. 1b. Referring to FIG. 1c, a domain name 30 or URL 32 may be displayed in a location bar or in relation to search results using a non-standard or customised font that may be chosen by the website owner, manager or controller of the domain name. Such a domain name and customised font may be registered with a domain registration service and have different elements and principles of design, which is a further example to emphasize the trade mark or brand. Referring to FIG. 1d, a domain name 30 or URL 32 may be displayed in a location bar or in relation to search results using a non-standard font or style to emphasize the trade mark or brand, or a tab may be customised using a non-standard font or style to emphasize the trade mark or brand. Typically, such a domain name 30 or URL 32 still constitutes a valid domain name or URL as recognised by a browser or search engine, and may or may not include a prefix, host or suffix such as “www.” or “.com” as may be applicable to that domain name 30 or URL 32. The domain name 30 or URL 32 which may be displayed by the browser or in a list of search engine results may constitute or comprise any suitable digital media such as font, style, size, colour or visual representation such as symbols, or embedded material. Such digital media may be registered by the website owner, manager or controller of the domain name on the domain registration service, and such a domain registration service may be contacted by a web browser or search engine.

The domain names shown in FIGS. 1b-d may provide greater artistic value to domain address, domain name 30 or URL 32 as displayed in a location bar or in relation to a search result, and therefore the domain name 30 or URL 32, tab content, search result or other such information displayed by the browser (which may include display in a location bar or display of a list of search results returned by a search engine) may be more obvious, noticeable, or aesthetically appealing to an end user than a standard or traditional domain name 30, URL 32, tab or search result. This may be executed by, for example, including use of various fonts, sizes, one or more colours, and this may add artistic or aesthetic value to the domain name 30, URL 32 or tab being used or displayed.

Further, as users may not be accustomed to viewing domain names 30, URLs 32 or tabs in a non-standard font type, size, colour or with another non-standard characteristic, a greater emphasis on the domain name 30 or URL 32 or tab or search result may be provided.

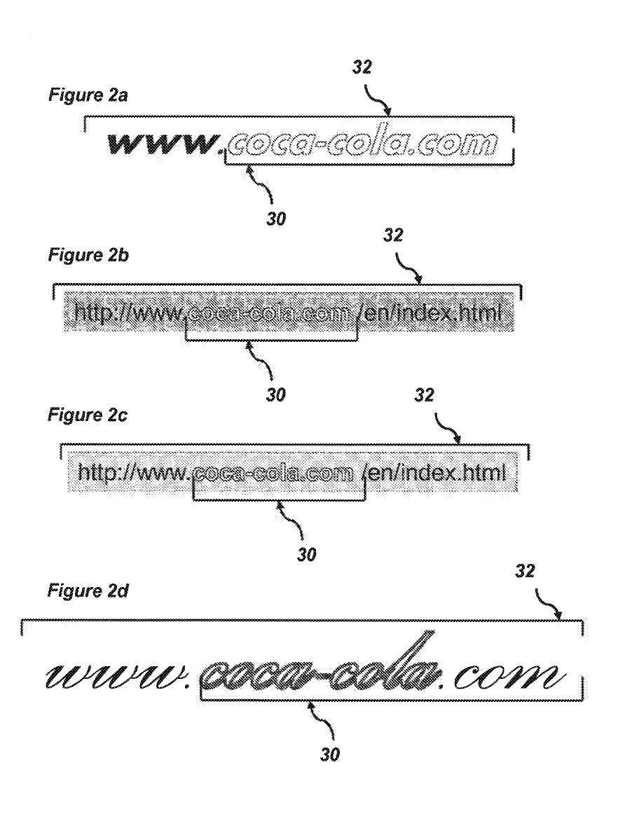

Referring to FIGS. 2a-d, further examples of customised domain names 30 and URLs 32 are shown. Referring to FIG. 2a, a domain name 30 and URL 32 which may emphasise a brand or colours scheme, such as that of Coca Cola. The string “cola-cola” may be displayed in red and the rest of the URL 32 may be displayed in black. The entire URL 32 may also be displayed in a non-traditional font. Referring to FIGS. 2b, c a domain name 30 or URL 32 may be displayed in a location bar or in relation to search results in a traditional font style and colour, but with a backing block of colour, which may add value to the domain address. The backing block may be any suitable colour such as red or black, or alternatively or additionally may comprise a pattern or static or moving image or any other suitable digital media, such as a shapes or various shapes and colours. Referring to FIG. 2d a domain name 30 or URL 32 may be displayed in a non-traditional font and with a coloured portion (for example, the string “coca-cola.”) and a black portion. This may emphasise a trade mark, brand, or colour scheme associated with a service, product, or company. The font may be a font associated with a company or brand. The example domain names 30 and URLs 32 of FIGS. 2 a-d may each be displayed in a location bar, browser, or in relation to a search result returned by a search engine.

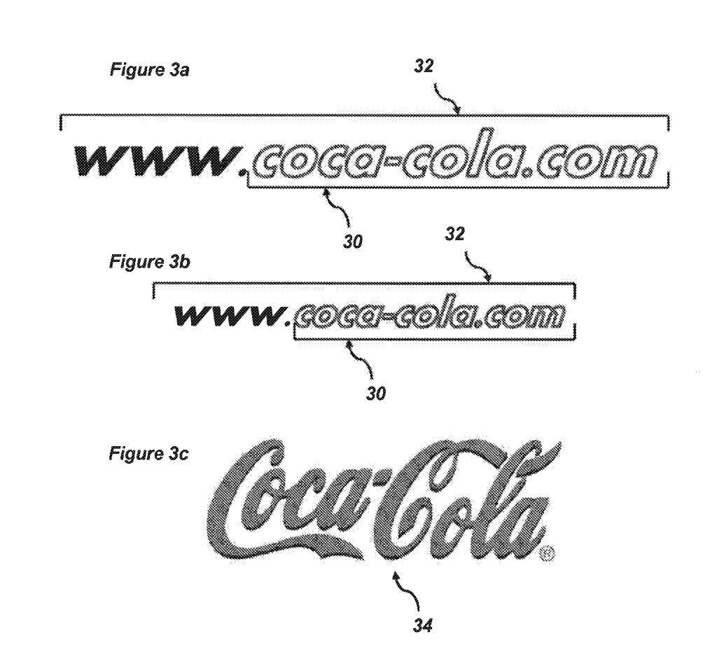

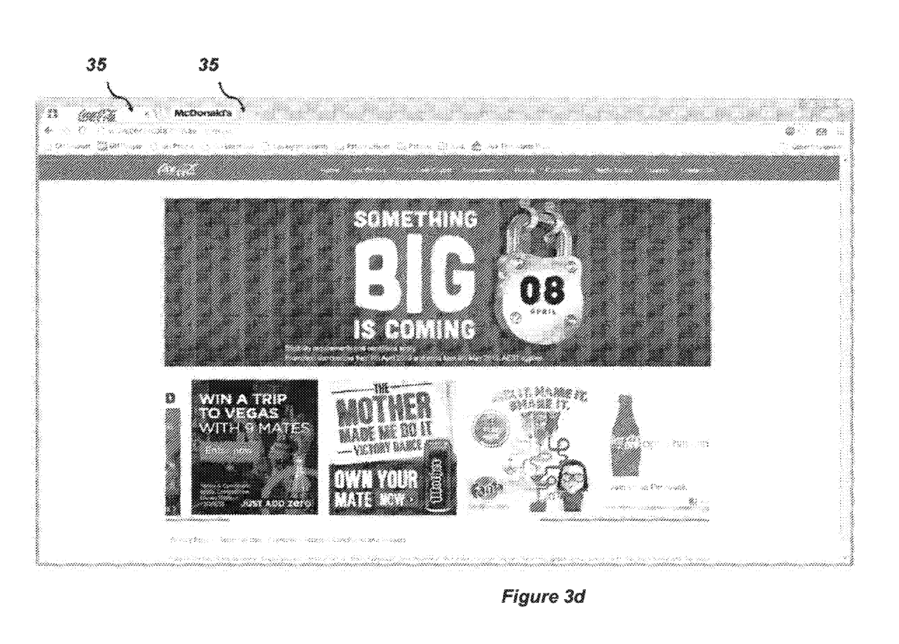

Referring to FIGS. 3a,b, further examples of domain names 30 and URLs 32 are shown. Referring to FIG. 3a, a domain name 30 or URL 32 may be displayed with a custom font, a coloured portion, a non-coloured portion and a size that is larger than usual. Such a domain name 30 or URL 32 may require a larger location bar or field for display, and a browser may be controlled to accommodate such a larger domain name 30 or URL 32. Such a field may or may not necessarily cover the width of the screen.

Referring to FIG. 3b, a domain name 30 or URL 32 may be displayed in a location bar or in relation to a search result fully in any one or more suitable colours, such as red, black or white, as is desired and controlled by the website owner, manager or controller on a domain registration service. If, for example, white font is used, a grey or black background could be also used, and in the domain name 30 or URL 32 of FIG. 3b, for example, a different colour background could be used, such as a yellow block, or any other background.

Referring to FIG. 3c, any suitable digital media such as an image or trade mark 34 (for example, of Coca Cola) may be displayed in the location bar or in relation to a search result. Typically, such a trade mark may correspond with the domain name 30 or URL 32. This may be implemented by the fonts or other file or files or other material received from the domain registration service. Alternatively, actual trade mark could be embedded into the location bar or domain name field. The field area may be changed, to fit the area required, for example, a rectangle for a trade mark or image towards the top left or right corner of a webpage, or in any other suitable location in a browser GUI. Any suitable combination of digital media such as one or more of a font, a colour, an image, a logo, a trade mark, a favicon, a video, or animation may be displayed in place of a domain name 30 or URL 32 in a location bar of a browser, and such a location bar may be provided in any suitable size, scale, shape or location with the browser or browser GUI, Alternatively and in some embodiments, the owner, manager or controller of the domain name 30 or website may register a custom font, colour, style or other suitable digital media with the domain registration service such that a domain name 30 or URL 32 may be displayed and recognised by a browser or search engine in a format such as that shown in FIG. 3c. The trade mark 34 may comprise an embedded hyperlink and, for example, upon clicking or other interaction may take the user to another site.

Referring to FIG. 3d, a web browser tab 35 may be customised in any suitable manner, such as with a custom font or image. Typically, the owner of a domain name will register the domain name with the domain registration service in a similar manner to the embodiments described herein, and will provide custom domain data related to or associated with the domain name 35, which is stored in the custom domain data database. The domain registration service, upon receiving a request from a browser that includes data indicative of a URL that is stored in the custom domain data database, sends the custom domain data to the browser, which may then control the appearance of the tab 35 according to the custom domain data. In embodiments where both the location bar and tab 35 are to be customised, the domain registration service may send all relevant custom domain data to the browser in a single message or a series of messages. The browser is typically configured to be able to distinguish which data controls the appearance of the location bar and which data controls the appearance of the tab 35, and the data may be flagged as appropriate to help achieve this.

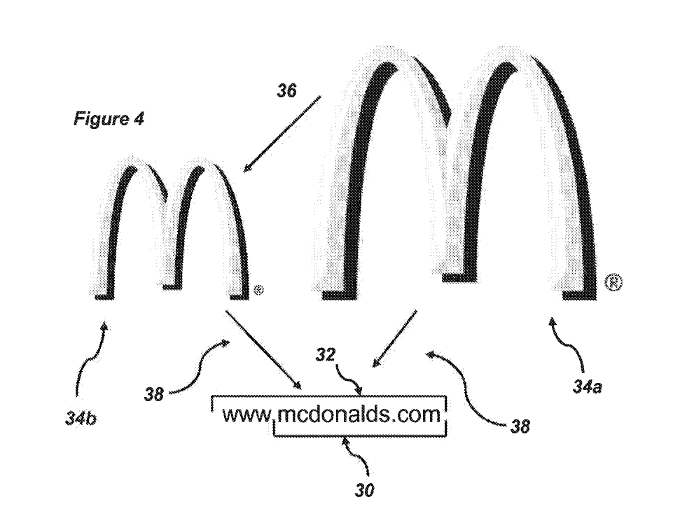

Referring to FIG. 4, displayed digital media such as a trade mark 34 may be interactive within a browser GUI, for example within a location bar, tab or within a list of search results. For example, a large trade mark 34a displayed in a location bar may be reduced 36 in size to a small trade mark 34b when a user interacts with the large trade mark 34b, for example, by clicking with a mouse on the same. The digital media, such as the trade mark 34, may be reduced or enlarged or otherwise transformed, and the interaction style (for example, enlargement or reduction) may be chosen by a user. Further interaction may, for example, transform 38 the trade mark 34 completely and, for example, cause it to be displayed as a domain name 30, URL 32 or both, Custom domain names 30 or URLs 32 (for example, as shown in FIGS. 1b-d, 2a-d and 3a-c) may be displayed after interaction with suitable digital media.

Alternatively, a user may interact, for example by clicking, on the large trade mark 34a and it may instantly transform 38 to custom or non-custom domain name 30 or URL 32. The user may be directed in the browser to the website associated with the domain name 30 or URL 32 upon interacting with the trade mark 34.

For example, a user may interact with the trade mark 34, which may comprise an embedded and clickable domain name or address. As such, the user may have a choice as to how much of the web page they would like displayed at any given moment, and can interact with the website.

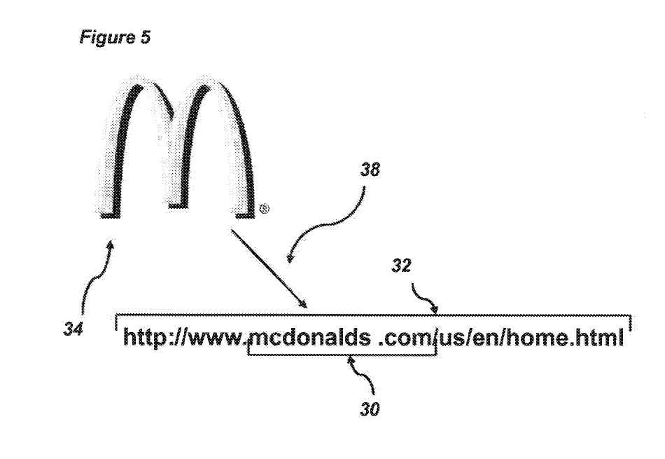

Referring to FIG. 5, a trade mark 34, may be visible or displayed to a user doing an image search through a search engine. In some embodiments, the user may be able to interact with or click the trade mark 34, or scroll or hover a cursor over it, such that it becomes interactive and may transform into 38 or direct a user to an associated custom or non-custom domain name 30 or URL 32.

In this embodiment, for example, the user may search for any image or other digital media, whether that be a trade mark or not, and by linking such an image or digital media to a domain name 30, URL 32 or tab, the user may then be directed to the associated website, or alternatively or additionally, further information or direction can be provided, for example, in a pop-up box.

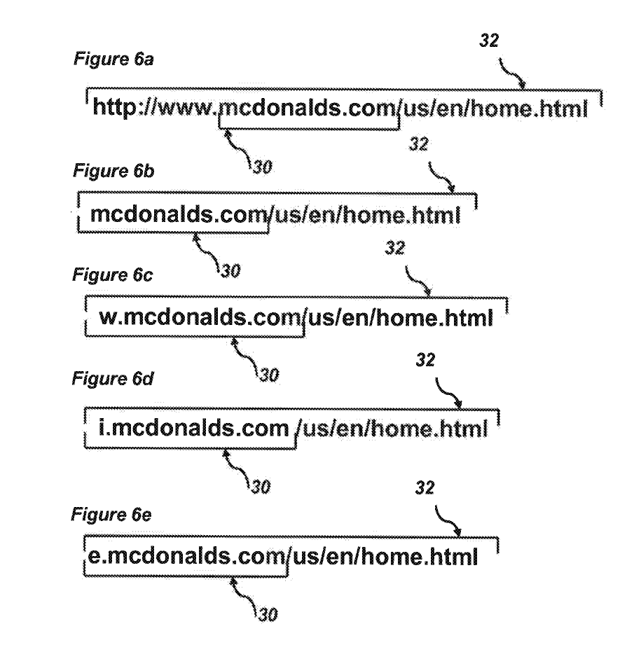

Referring to FIGS. 6a-e, a series of domain names 30 and URLs 32 are shown. The domain name 30 or URL 32 of FIG. 6a may be a standard domain name or URL as is already known. In some embodiments and referring to FIGS. 6b-e, examples of related but different domain names 30 or URLs 32 that may be displayed in a location bar or in relation to search results are shown. Referring to FIG. 6b, a domain name 30 or URL 32 may be controlled to not display a typical domain host or prefix or suffix such as “http:www.” or “www.” or “.com”. Referring to FIG. 6c, the domain name 30 or URL 32 may be controlled to display “w.” as the prefix. Referring to FIG. 6d, the domain name 30 or URL 32 may be controlled to display “i.” as the prefix. Referring to FIG. 6e, the domain name 30 or URL 32 may be controlled to display “e.” as the prefix. The location bar or search engine results may be controlled to display any suitable host, prefix or suffix associated with a domain name 30 or URL 32. Other prefixes or suffixes may be used.

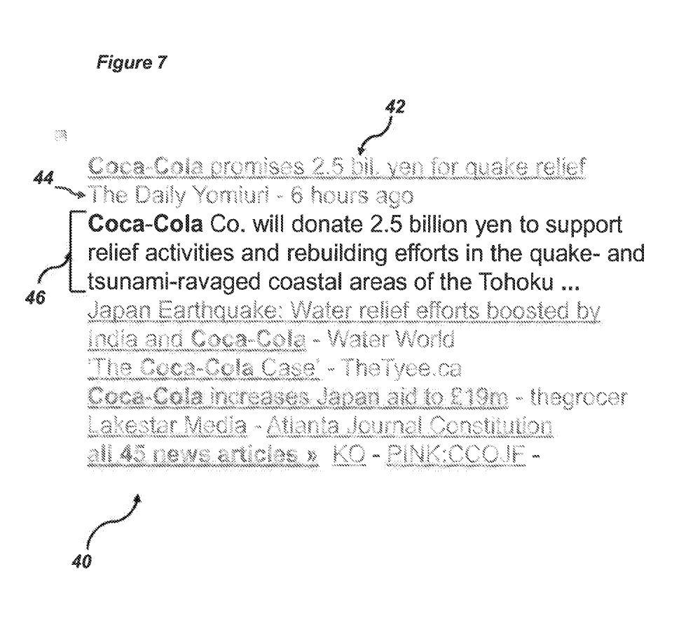

Referring to FIG. 7, a search result 40 may comprise a heading 42 (which may also be a link to an associated website or webpage), a text-based website title 44, and a text-based summary or extract 46 of the website contents. Such a search result 40 may be displayed in a browser in response to a search query input by a user to a search engine.

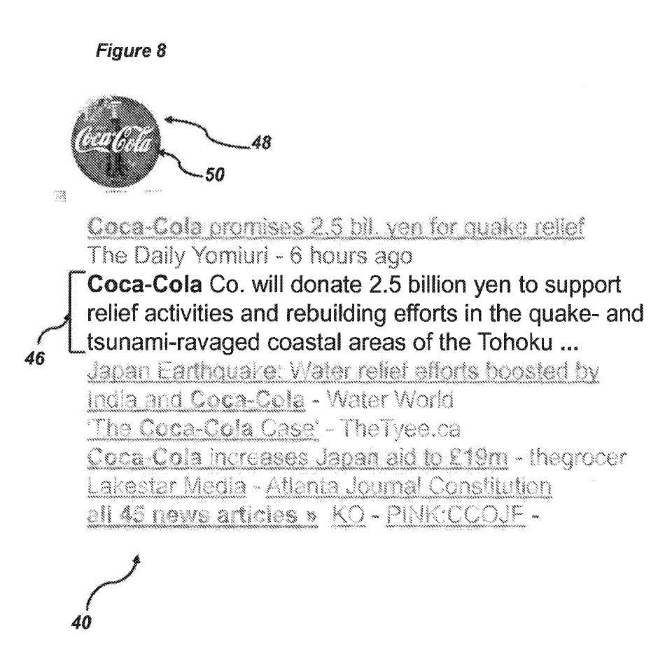

Referring to FIG. 8, in some embodiments, the search result 40 may be controlled to display any suitable digital media 48 such as one or more of a font, a colour, an image, a logo, a trade mark, a device, a favicon, a video, or animation. For example, a Coca-Cola logo 50 may be displayed in relation to a search result related to Coca-Cola. Such embodiments may provide a user with the advantage of seeing a visual representation of the text results, which may be easier to scan, search or browse. The digital media 48 may be embedded and may have an embedded link or hyperlink which can be clicked on to go to directed information, such as website or webpage. Alternatively, clicking on the digital media may reveal pop-up information such as a promotion, or may be the same or different to that seen in the extract 46, or thumbnail of website. In other embodiments, the digital media 48 may not be interactive, but may provide brand recognition. This may indicate to a user that the search result 40 corresponds to an official website, such as to Coca-Cola. The use of such digital media 48 displayed in relation to a search result 40 may include greater exposure for a company, more advertising for a company, more space taken up in a list of search results 40, more than one way to click through or navigate to a web site, or the ability for a user to identify official or authentic web sites from others.

The digital media 48 may be displayed in any suitable location on a webpage or in a list of search results, such as at top or above a search result 40 as shown in FIG. 8, or behind or on top of text (in which case the digital media 48 may be opaque), or to the left or right, below, or in any other suitable location.

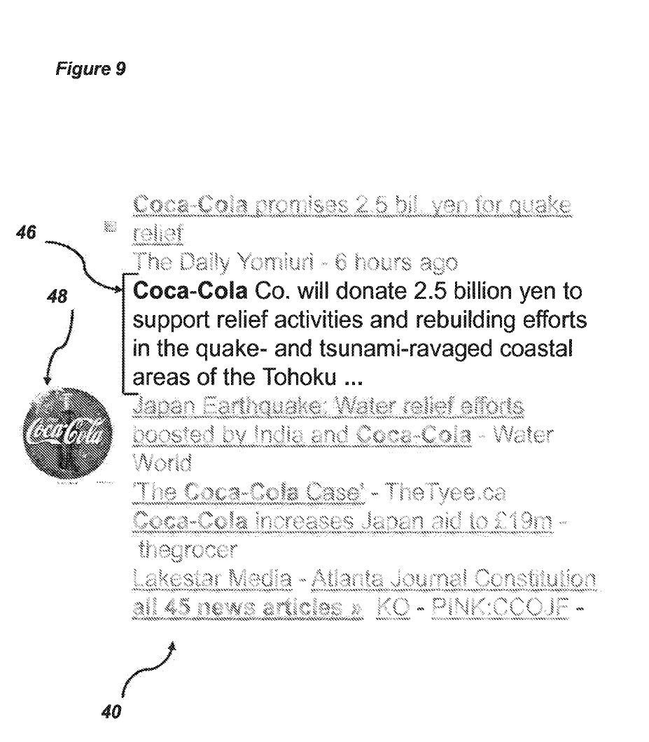

Referring to FIG. 9, a search result 40 may be controlled to display any suitable digital media 48 to the left of the extract 46. The search result 40 may be displayed over a larger area when compared with the example of FIG. 8.

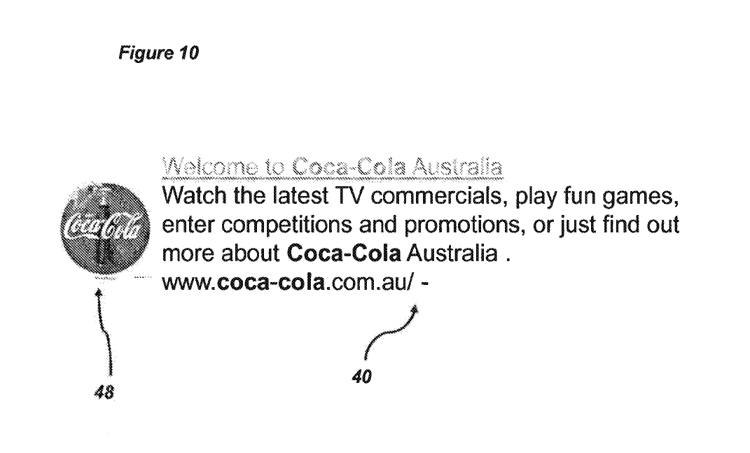

Referring to FIG. 10, another example of a search result 40 layout, with digital media 48 displayed to the left, is shown.

Referring to FIGS. 7 to 10, any suitable digital media 48 may be displayed in any suitable relation to any search result 40 in a list of displayed search results 40 as may be returned by a search engine in relation to a user's search query. The digital media 48 may be displayed in any suitable browser, whether that be web or otherwise, that is arranged to display text and such digital media 48 in proximity or underlaid or overlaid. The digital media 48 may be provided in any suitable shape or size, and in any browser relating to the internet.

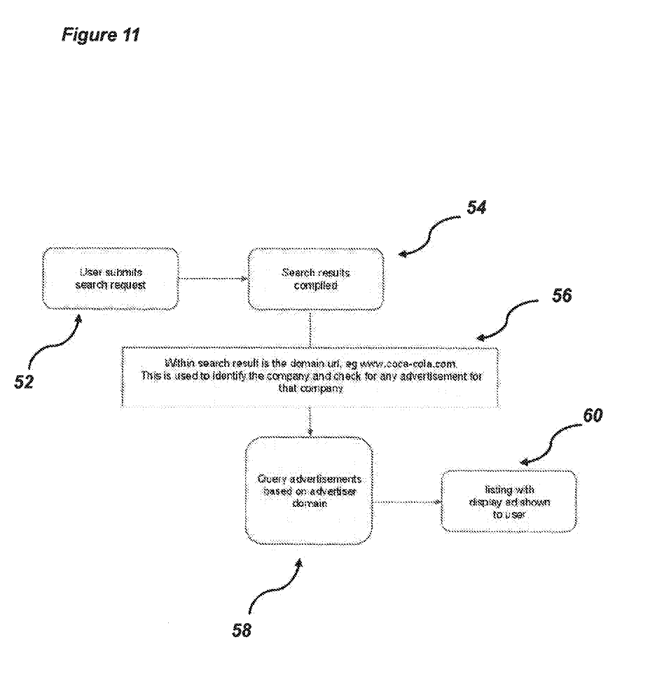

Referring to FIG. 11, a method of an embodiment may comprise a user sending or submitting a search query 52, for example, from a browser to a search engine over the internet. The search engine may receive the search query and compile one or more search results 54, for example by using an index. The URL of each search result may be parsed to extract a domain name or other identifying characteristic 56. The extracted domain name may be provided on and matched to an entry on a domain registration service database 58. If a domain name matches an entry on such a database, custom domain data may be sent to the browser, along with the search results, such that any suitable digital media may be displayed in relation to corresponding search results 60.

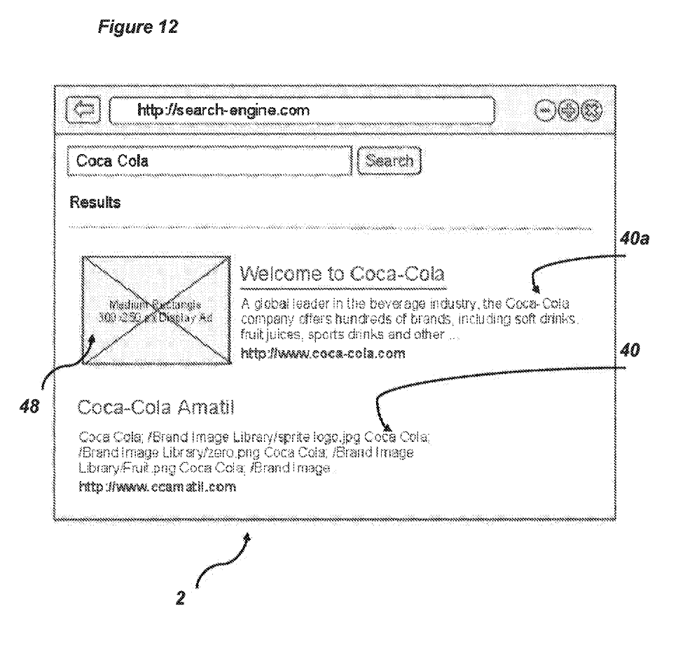

Referring to FIG. 12, a browser 2 may be controlled to display one or more search results 40 in response to a user's search query. The user, having executed a search, may be presented with digital media 48 displayed in relation to certain search results 40a whose corresponding domain name, or at least part of URL or website has been registered with the domain registration service.

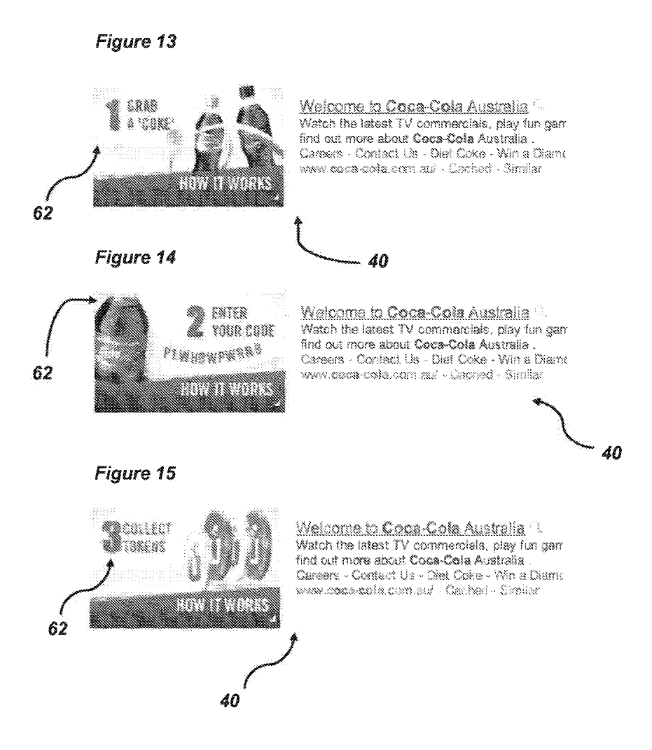

Referring to FIGS. 13 to 15, animated digital media 62 may be displayed in relation to a search result 40 whose corresponding domain name, URL or website has been registered with the domain registration service. Such digital media 62 may sequentially change or update, as shown by the progression from FIG. 13 to FIG. 14 to FIG. 15. In this way, a user may be presented with or see an animated or live advertisement, for example.

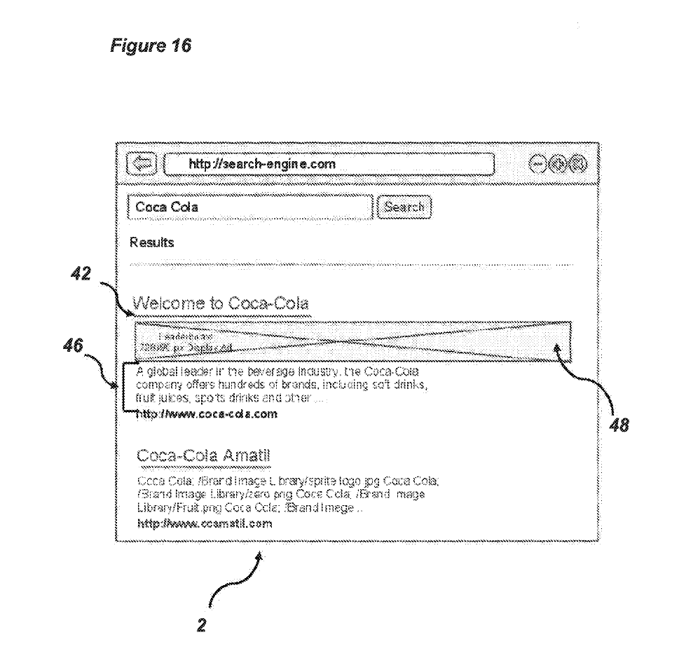

Referring to FIG. 16, in some embodiments, a browser 2 may be controlled to display any suitably sized digital media 48 in relation to a search result, for example, between the heading 42 and extract 46.

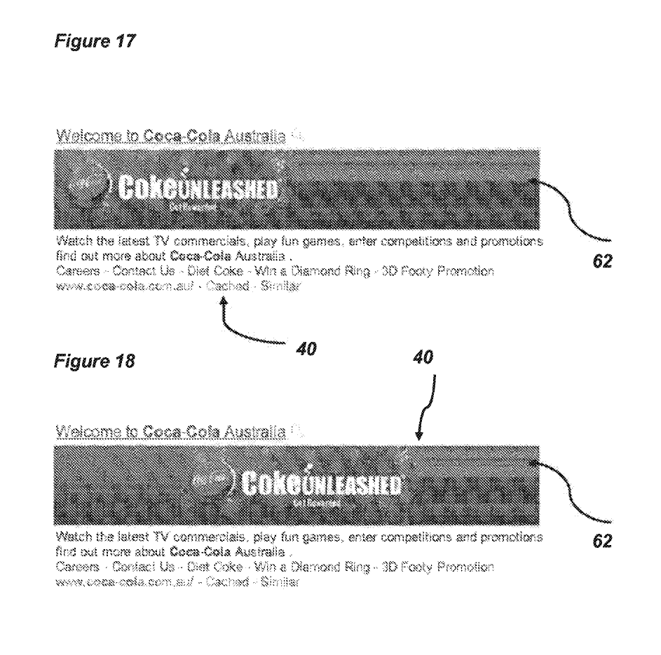

Referring to FIGS. 17 and 18, such digital media may be animated digital media 62 as shown by the progression from FIG. 17 to FIG. 18. The digital media 62 is sequential and, as such, advertisements or other digital media may be animated, or static, or any suitable combination of the same If animated digital media 62 is employed or utilised, the animation may run, for example, for 0.1 seconds through to 60 seconds, or any other suitable time period.

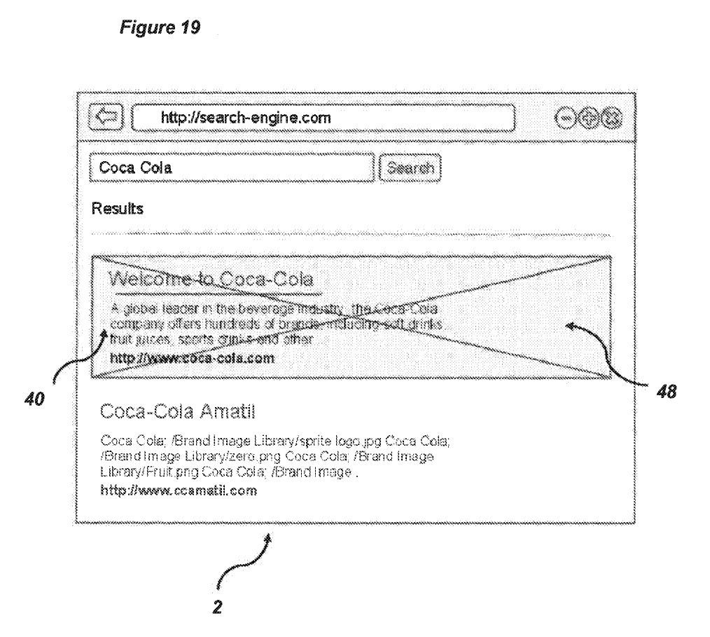

Referring to FIG. 19, in some embodiments, any suitable media 48 may be provide below or above the text of the search result 40 as displayed in a browser 2. In such embodiments, the digital media 48 may be, at least, partially transparent. Alternatively, the digital media 48 may be solid. The whole area of a search result 40 may be overlaid or underlain with any suitable digital media 48, such as an advertisement. The digital media 48 may be interactive and may, for example, change when a user scrolls or clicks cursor on it. Further, the digital media 48 may comprise an embedded image or animated advertisement.

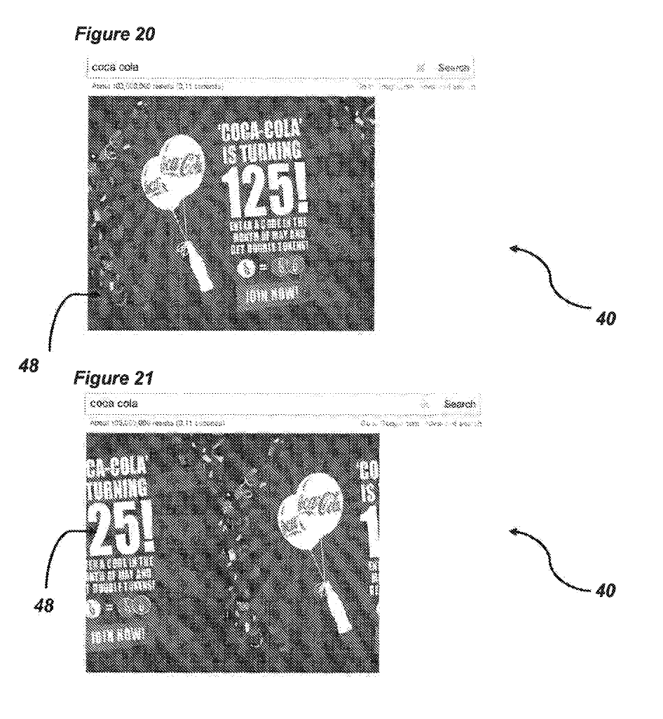

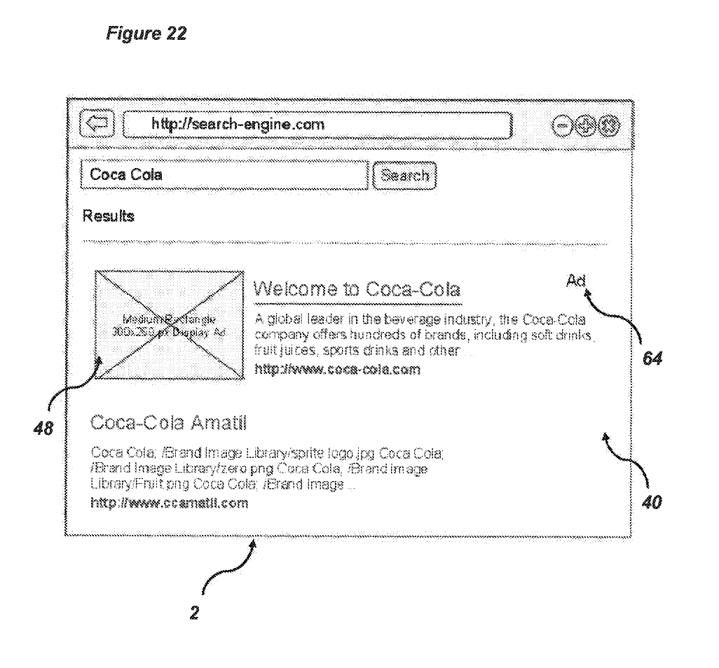

Referring to FIGS. 20 and 21, suitable digital media 4a may be displayed in place of any search result text. For example, the entire search result may be replaced with digital media 48, such as an animation as shown in the progression from FIG. 20 to FIG. 21. Referring to FIG. 22, in some embodiments, suitable digital media 48 may be displayed in relation to a search result displayed on a browser 2. In such embodiments, the text of the search result 40 may be shifted to allow the digital media 48 to be displayed unobstructed in an area normally occupied by the search result 40 text. In such embodiments, a phrase or word 64 such as “Ad” (for example, referring to a paid advertisement) may be displayed in any suitable location in relation to the search result 40, such as in the top right hand side. Such embodiments may require subscription to a “premium” service of the domain registration service.

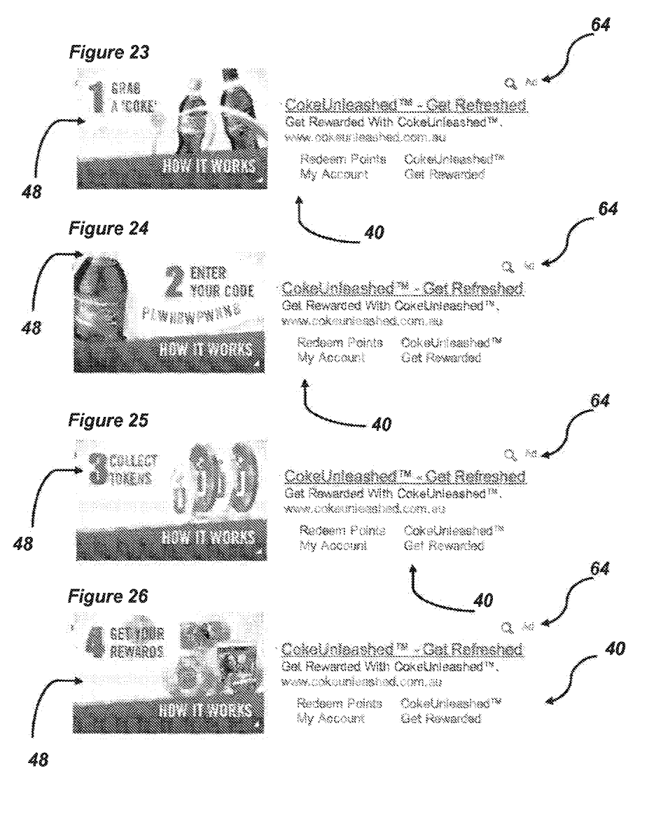

Referring to FIGS. 23 to 26, in such embodiments the digital media 48 displayed in relation to a search result 40 may be animated as indicated by the series of FIGS. 23, 24, 25, and 26. The animation may appear seamless and appear as a television advertisement or video. A user may see one or more of the frames of the animated digital media 48. The word 64, for example “Ad”, may or may not be provided as necessary.

In some embodiments, the browser or digital media 48 may have embedded, or otherwise, controls that provide the use with the ability to stop, pause, replay, rewind, fast forward, seek or otherwise interact with the search result 40, digital media 48, or both.

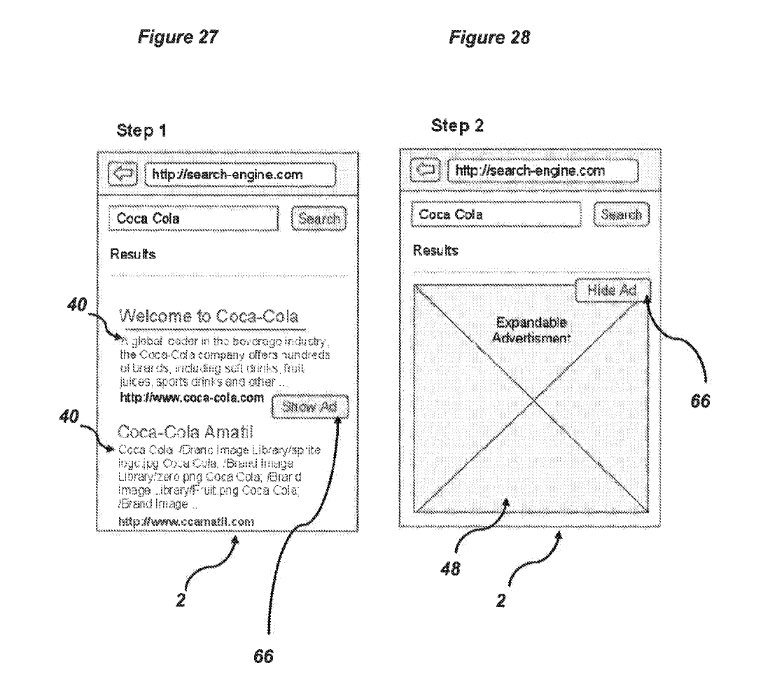

Referring to FIGS. 27 and 28, in some embodiments, a browser 2 may be provided on a small screen, such as that of a mobile phone or PDA. In such embodiments, a user may be provided with a button 66, which, when clicked, pressed, touched or similarly actuated, may expand or otherwise reveal suitable digital media 48 in place of or in proximity to a search result 40. The digital media 48 may be revealed, expanded, or otherwise interacted with in any suitable manner and through any suitable mechanism. For example, a browser may display one or more search results 40 on a browser 2. A user may press the button 66. Referring to FIG. 28, after pressing the button 66, suitable digital media 48 may be revealed and may occupy any suitable part of the search result or browser 2. This may be advantageous for a user with a client comprising a small screen, such as a mobile telephone. However, such embodiments may be provided in relation to any suitable screen size, such as a screen on a personal computer or tablet.

As such, a browser 2 provided on a client with a small screen may be controlled to display one or more search results and an associated button 66 which may be arranged to expand or otherwise change the size or location of suitable digital media 48, such as an advertisement. This may be advantageous for a user using a client comprising a small screen, for example a mobile phone. The user may press the button 66 to expand the digital media 48 for enhanced viewing. Alternatively or additionally, the user may expand or shrink the digital media 48 to any desired size or proportion of the browser 2 by dragging a suitable area, for example, the corners, of the digital media 48. The user may click, press, slide a finger over, or otherwise interact with the button 66 or digital media 48 in order to reduce the size of digital media 48, or hide it completely.

The digital media 48 may be provided in any suitable shape or form, and may be interactive in any suitable manner. Interaction with the digital media 48 may cause it to increase in size, reduce in size, appear or disappear, begin or stop an animation, or change or stay the same in any suitable manner.

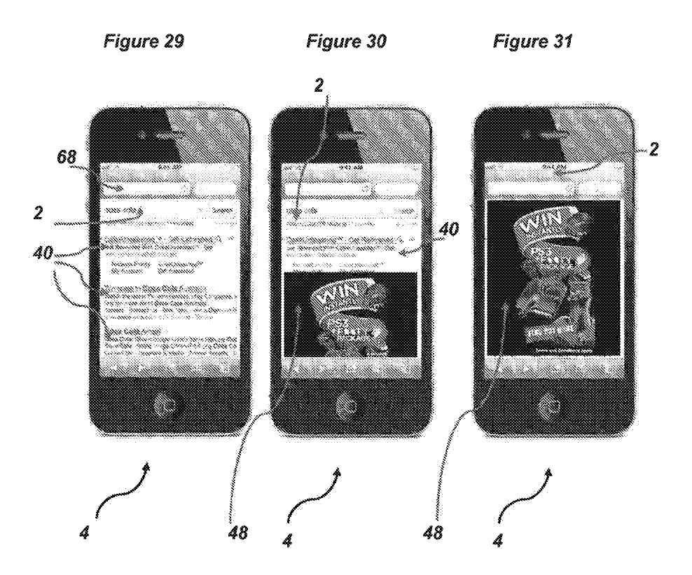

Referring to FIG. 29 a medium or client 4 (typically with internet or other network access) may comprise a browser 2 arranged to display a customised domain name or URL in a location bar 68, or one or more search results 40 in response to a user's search query. A particular search result may have associated digital media, although it is not shown or displayed in FIG. 29.

Referring to FIG. 30, the browser 2 of the client 4 may be controlled to display suitable digital media 48 in relation to a search result 40 corresponding to a domain name, URL or website that has been registered with the domain registration service. The digital media 48, such as an advertisement, may be controlled to be displayed, for example, in response to an input from a user or automatically. The digital media 48 may be expanded in the browser 2 in any suitable manner, for example, by a user sliding a finger or stylus across a touchscreen, or by clicking on a particular search result 40. The digital media 48, as all others referred to herein may be any suitable combination of digital media such as one or more of a font, a colour, an image, a logo, a trade mark, a favicon, a video, or animation. The digital media 48 may be contained in any suitable file, file type or database and may comprise an advertisement that is static or animated or presented in any other suitable manner. FIG. 30 shows digital media 48 in the form of an advertisement that has been controlled to rise from the bottom of the browser 2 GUI, is partway through its rise, and presently occupies approximately the bottom half of the browser 2 GUI.

Referring to FIG. 31, the digital media 48 (as shown in FIG. 30) advertisement has completed its rise from the bottom of the browser 2 and now occupies a large proportion of the entire browser 2 GUI and screen of the client 4. Animation of digital media 48, such as IC an advertisement, may run, for example, for 0.1 seconds through to 180 seconds, or any other suitable time period. It may be advantageous to run an advertisement for 1 through 30 seconds.

The digital media 48 may be static or animated (similar to a television advertisement). The digital media 48 may be provided in any suitable format or file such as an mpeg, Flash, or any other type of sequential frame by frame set of images. A provider may determine the type or length of such a tile or format.

Any size, type or form of digital media 48 may be controlled to be displayed on a browser 2 of a client 4 or medium. For examples, the digital media 48 may be provided or displayed in other parts of the browser 2 or screen, such as the top, one or both left and right hand sides or bottom. More than one instance of digital media 48 may be displayed on single a webpage, or URL location, any each instance may be of various or different sizes, and each instance may be independently interactive.

The digital media 48 may or may narelate to a particular domain name. URL or website corresponding with a search result and being registered with the domain registration service.

The digital media 48 may or may not comprise an embedded link.

The digital media 48 may be provided in any suitable position any suitable browser 2, and may be made up of one or more scrolling advertisements or static advertisements. The digital media 48 may relate to particular search results and may be provided as panelling or in any suitable area of the browser 2 or screen, such as towards the top, bottom, middle, left or right.

The digital media 48 may be of any practical or suitable shape or size, and be provided on any suitable of browser 2 or page.

The digital media 48 may, for example, be provided or displayed as a square, ranging in size from 1 mm square to 20 m square (as screen sizes may vary greatly) via increments of 0.1 mm, and may be provided, for example, as a movie poster size. Alternatively or additionally, the digital media 48 may be displayed as a rectangle or any other suitable shape with any suitable dimensions.

The digital media 48 may be of any suitable dimension in increments of 0.01 mm throughout the range of any suitable height and width, such as, a full movie theatre size screen, or large scale outdoor billboard, which may be directed or related to a domain name, URL or website such that digital media 48 may be displayed thereon.

The same may also be used to download information to a billboard of any size. The billboard display may be controlled or directed by a domain link or URL link, wherein the billboard displays digital media 48 base on information or a direction from the domain address link.

The digital media 48 may be advertising of any suitable type or form, such as static images, animation or recordings such as television or movie recordings.

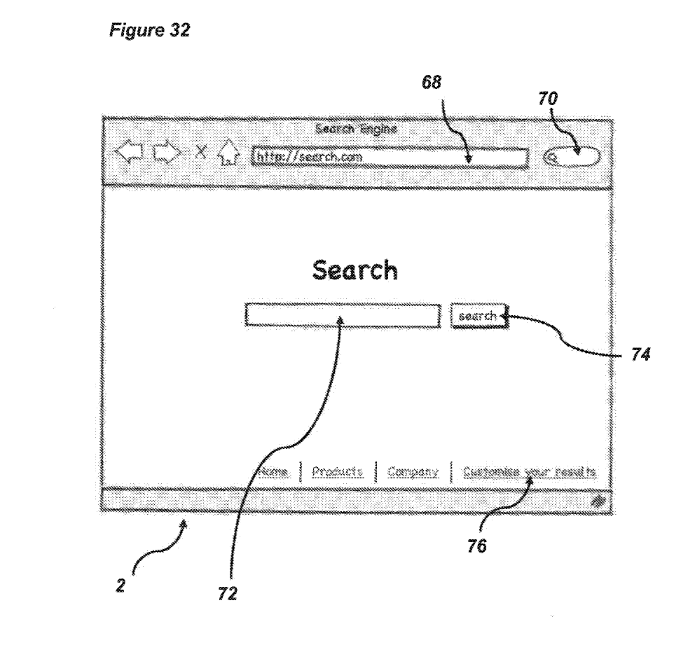

Referring to FIG. 32, a browser 2 may comprise a location bar 68 arranged to display a domain name or URL, one or more tabs for tabbed browsing (not shown) and a search toolbar 70. In some embodiments, the location bar 68 and search toolbar 70 may be combined. The browser 2 of FIG. 32 is displaying a search engine webpage, the webpage comprising a search input textbox 72 and search button 74. The search toolbar 70 and input textbox 72 may each be arranged to accept a content or text-based search query from a user. The search engine may perform an internet search based on the search query when a user submits the search query, for example, by clicking on the search button 74. The search engine may display a list the search results. The browser 2 or search engine is typically arranged to display customised search results. A link 76 may be provided on the search engine homepage that enables domain name, URL or website owners or managers to access a search result customisation management application.

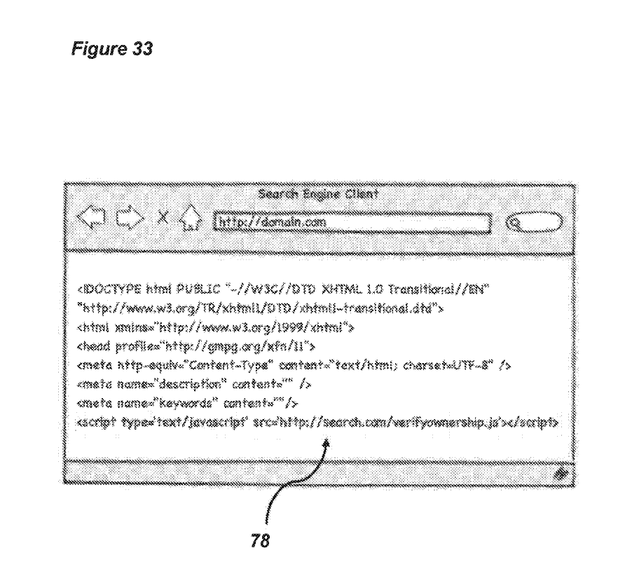

Referring to FIG. 33, a website manager may be required to verify domain name. URL or website ownership. The owner may nominate an owned domain name or URL and may be required to provide proof of that ownership. More than one method may be provided. For example, a method of ownership verification may comprise inserting java script code 78 into a web page within the domain name that the search engine may use to verify ownership. Any other suitable method may be provided.

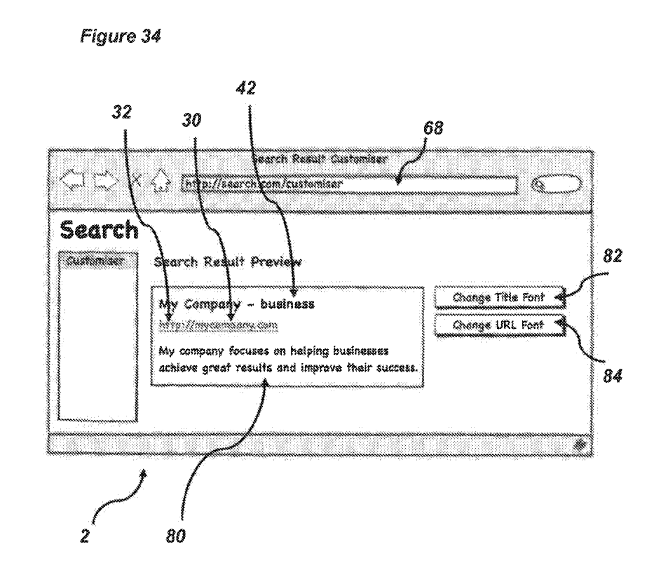

Referring to FIG. 34, the domain registration service may be logged into by a website owner. Once logged in, the browser 2 may display an interface or be controlled to display a preview 80 of a search result returned in relation to the owned domain name. URL or website as displayed to a user in response to a search. The domain registration service may provide the ability for the owner to customise the appearance of the search result. The preview 80 may display how a particular search result for the particular domain name, URL or website will appear to a user. This may provide the domain owner with a visual cue as to how a search engine user will see the search results for results that correspond to their controller or owned domain name. URL or website. The controller or owner may also be provided with options to modify the appearance of the displayed customised search result. For example, a change title font button 82 or a change URL font button 84 or both may be provided and, when clicked by the owner, may provide options to modify the appearance of the search engine heading 42 and domain name 30 or URL 32 respectively, as displayed to a user in a list of search results. The appearance of a domain name 30 or URL 32 may similarly be customised by an owner for display within the location bar 68 of a web browser 2, search engine field line or search results. The appearance of the content of a tab may similarly be customised by an owner for display when an owner's website is viewed on a browser.

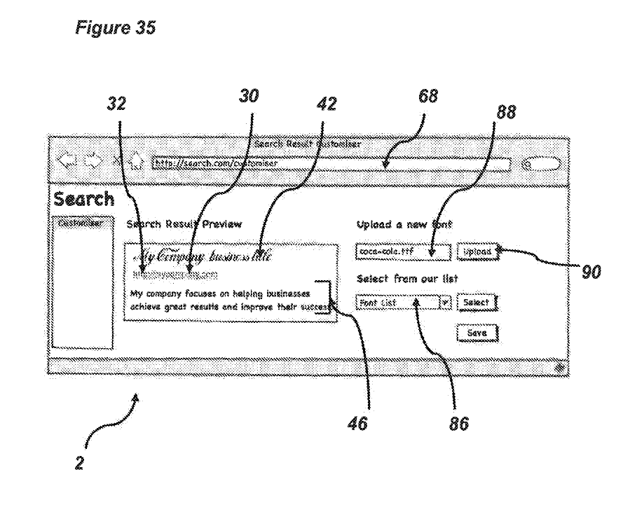

Referring to FIG. 35, an owner may be able to change or modify the appearance of a search result by selecting or providing a replacement font. The appearance of the heading 42, domain name 30 or URL 32 or extract 46 may be modified as desired. Alternative or additional fonts may be provided by the domain registration service, or alternatively an owner may upload a custom font. Different fonts may be applied to the heading 42, domain name 30. URL 32, or any other suitable information provided within the search result or domain name, or any other suitable aspect of the search result. A URL, domain name, or website controller or manager may be presented with one or more customisation options to customise any suitable part of the search result with digital media such as the heading 42 or extract 46. Additionally, or alternatively, the URL, domain name, or website controller or manager may be able to add and define the location of any suitable digital media such as a combination of one or more of a background colour, image, logo, trade mark, favicon, video, or animation. For example, the URL, domain name, or website controller or manager may wish to change the heading 42 font. The URL, domain name, or website controller or manager may upload a desired font file to the domain registration service by specifying the font file location (for example, on the controller's or manager's machine) in a text box 88 and clicking an upload button 90. Alternatively or additionally, the manager may be able to choose from a provided list of fonts, for example, from a drop-down list 86. The manager may customise other aspects of the search results, such as the search result extract 46, in a similar way, although any customisation may be done in any suitable manner. Any uploaded files may be saved to an account associated with the manager and may be applied to customisation schemes for other domains the controller or manager may own and have registered.

Alternatively or additionally, a URL, or domain name, or website controller or manager may provide a pointer. URL or IP address to any required digital media. Any uploaded files or pointers or the like may be stored on the domain registration service server and sent to a user's client as required.

Alternatively, or additionally, the URL, or domain name, or website controller or manager may be able to customise the appearance of the domain name 30, URL 32 or tab as displayed in the location bar 68 of a browser 2 in a similar manner.

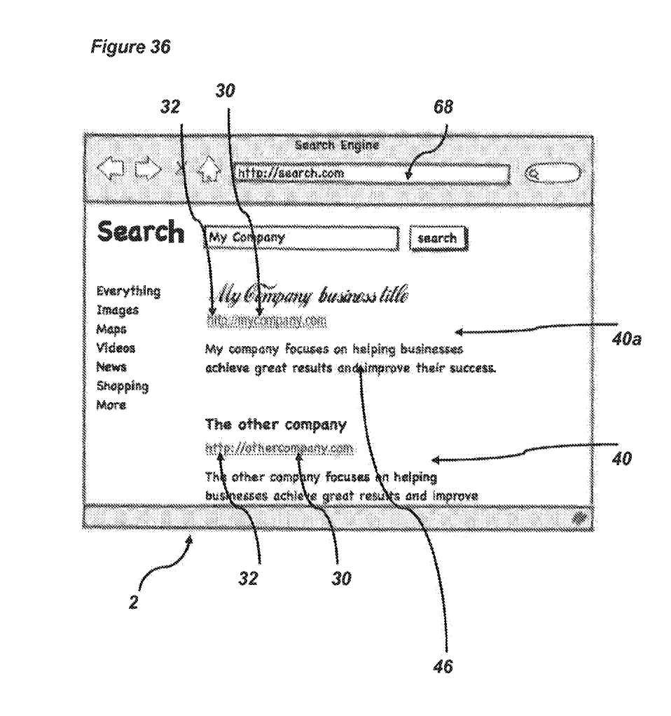

Referring to FIG. 36, a browser 2 may be controlled to display a customised search result 40a within a list of search results 40 in relation to a domain name 30. URL 32 or website that has been registered with the domain registration service. The customised search result 40a may appear as specified by an owner and may appear as in the preview. The appearance of a customised search result 40a for a registered domain name 30, URL 32 or website is typically displayed consistently with what is displayed in the preview to the domain owner. This may cause the customised search result 40a stand out or be distinguished from other search results 40 in the list. A customised search result 40a may be recognisable when brand fonts are used. Similarly, a customised location bar 68 may be recognisable when brand fonts are used. Additionally, a customised text file or a text file that is able to be customised may be uploaded to the domain registration service. Such a text file may be displayed in addition to or in place of any suitable part, or all of, the search result 40a. For example, a customised text file may be displayed in addition to or in place of the search result extract 46. This may allow an owner or controller to control, for example, the text of the extract 46 as displayed to a user.

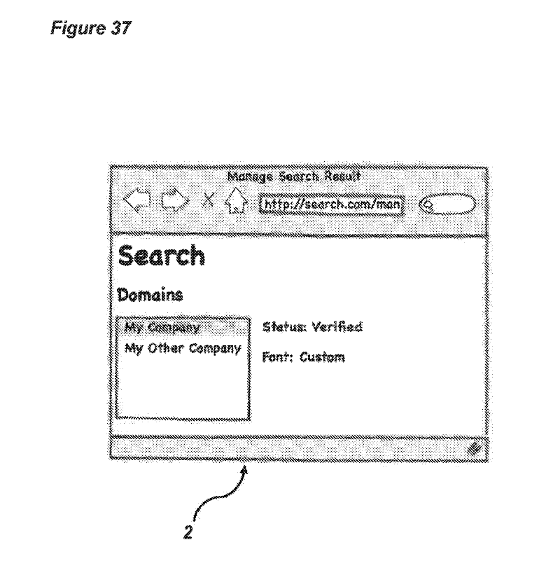

Referring to FIG. 37, the customisation method or process of FIGS. 34 and 35 may be repeated for each domain name, URL or website owned. A URL, domain name, or website controller or manager may control more than one domain name, URL, domain name, or website, and such multiple domains may be managed or customised from the same application or single account with the domain registration service. The browser 2 may display an interface which lists each website, domain name or URL that a website manager has registered with the domain registration service.

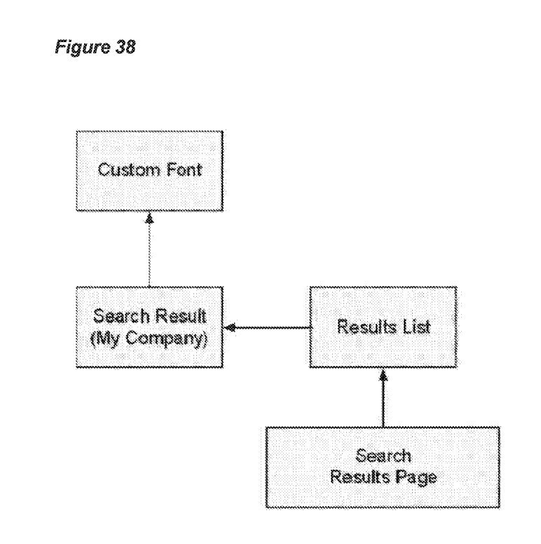

Referring to FIG. 38, the appearance of one or more domain names or URLs or tabs as displayed to a user in the location bar may similarly be customised from an application, interface or domain registration service account. For example, the one or more file to embed, or font of the URL or tab content may be customised, in addition or alternate to any font or other characteristic customised in the search results. This may be achieved by uploading font files, character files, or any other suitable files such as one or more image file.

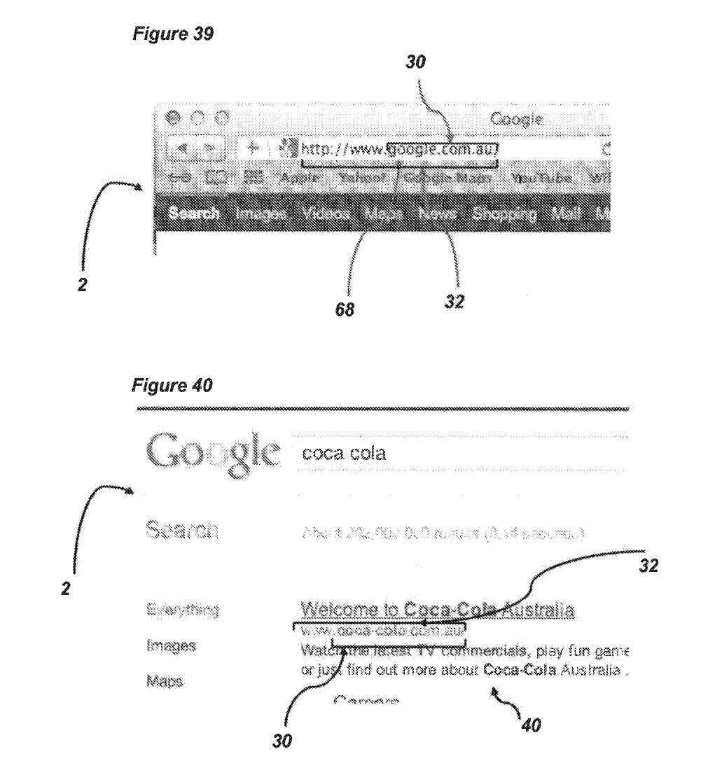

Referring to FIG. 39, a browser 2 may comprise a location bar 68 which is arranged to display a domain name 30 or URL 32 or both.

Referring to FIG. 40, a browser 2, in response to a search query, may be controlled to display one or more search results 40 returned by a search engine. Each search result may comprise a domain name 30 URL 32.

In some embodiments, the controller of a domain name. URL or may customise the display of the letters comprising the domain name or URL within the location bar by choosing from one or more pre-loaded fonts supplied by the web browser, search engine or domain registration service. Alternatively, the owner may upload a unique custom file to embed, or font onto the domain registration service. Similar customised font or images may be applied to the content of a tab of the browser.

The domain registration service may comprise a server operated by a web browser provider, search engine provider or other party. The domain registration service may comprise a database comprising a list of registered domain names, URLs, or websites that have nominated the use of a custom font, and the corresponding font, digital media, or other file to be used. Alternatively, the domain registration service may comprise any other system, format or tool arranged to provide a web browser or search engine with any suitable combination of suitable digital media such as a file, image or video. Such files may be designated by the controller or manager of a domain name in order to customise the appearance of the URL, domain name, search result, web page title or description as displayed by the web browser.

In some embodiments, as an alternative to customising individual font characters, a user may provide one or more files, such as an image file, which may be embedded into at least part of the location bar, or into at least any part of the search engine field line or results. The domain registration service may comprise a database that contains a list of registered domain names, URLs or website, and the corresponding file to be used.

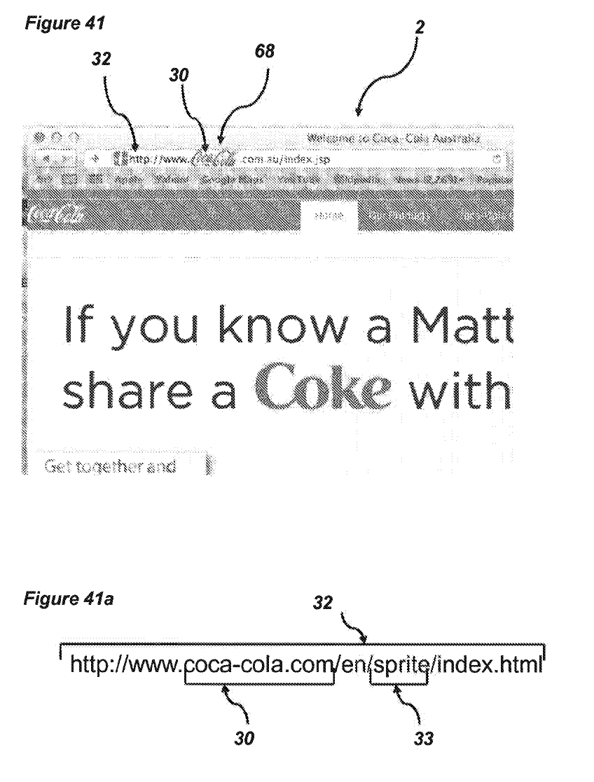

Referring to FIG. 41, a browser 2 may be controlled to update the appearance of the domain name 30 or URL 32 displayed by the location bar 68, or the browser may be controlled to update the appearance of the tab displayed, or both. Each time the location bar is updated with a customised appearance, the registered font, image file, or other digital media may be applied, for example, to either the domain portion or the entire displayed URL.

The domain registration service may comprise an application programming interface arranged to allow the browser 2 or search engine server to request information indicating whether or not a domain name or URL has been registered by using, for example, a key-value pair such as <domain, custom domain data>. It may be advantageous to use a key-value, scalable database such as a Redis database, although any appropriate database may be used.

Referring to FIG. 41a, a person, company or URL or domain name controller or manager may, for example, own more than one brand. Such multiple brands may be disclosed, advertised, or otherwise displayed on a single website controlled by the manager. For example, Coca-Cola may also own the “Sprite” brand, and Sprite may have its own dedicated section within the Coca-Cola website. Such a dedicated section may be represented by additional information related to the URL, such as the string “sprite” 33 within the URL 32. Additional information may be a sub-domain or represented in the domain 30 or URL 32 in any suitable manner. The browser or search engine may be arranged to send a request for custom domain data to the domain registration service, where the request comprises such additional information. For example, by sending the whole URL to the domain registration service. The domain registration service may comprise in its database additional or different custom domain data related to the additional information. The domain registration service may send to the browser or search the additional or different custom domain data upon receiving a request for custom domain data comprising the additional information. In this respect, it will be appreciated that the database of custom data could be indexed by registered domain names but contain multiple entries for some of the domain names. In such an embodiment, the domain registration service may be arranged such that it initially searches the database with the domain name and upon discovering that there are multiple items of custom content for the domain name, it may then check whether the URL contains a string corresponding to a specific item of custom content. In one example, there may be generic custom content that is returned unless a specific string is contained in the URL. The additional or different custom domain data may be displayed by the browser in a suitable manner such that, for example, a brand or digital media relating to the additional information is displayed. For example, the browser may receive custom domain data comprising a Sprite logo image file in response to sending the “sprite” string 33 to the domain registration service. The Sprite logo may be displayed in the location bar such that a user may visually identify from the location bar that they are currently browsing the Sprite section of the Coca Cola website.

Accordingly, it will be appreciated that where other embodiments above describe sending a domain name to the domain registration service, this could also be achieved by sending the entire URL or a portion of the URL with the domain registration service extracting the domain name or some other portion of the URL depending on how the database is indexed. Further, in other embodiments, the domain registration service could be arranged to return multiple items of custom content data to the browser, such that if the user operates the browser to navigate to a different portion of the website corresponding to different custom data, the different custom data can be displayed without the browser communicating with the domain registration service again for that instance. Alternatively, data may be communicated to the browser that informs the browser that it needs to retrieve different custom data upon the user browsing to specific parts of the website. In this respect, it will be appreciated that in some embodiments, the browser may be arranged to present the same custom data in the address bar while the user continues to navigate within the same website.

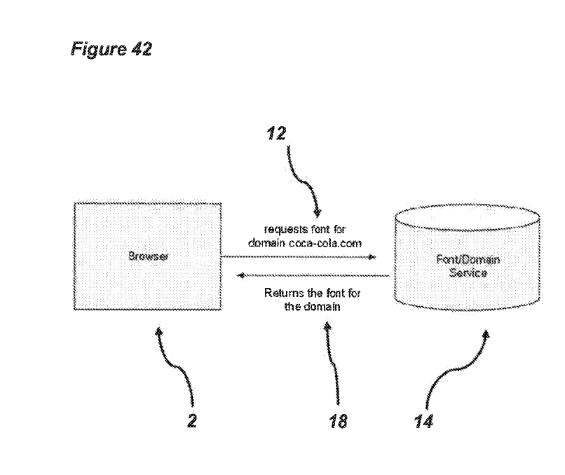

Referring to FIG. 42, a browser 2 may send 12 a request for custom domain data to the domain registration service 14. The domain registration service 14 may send 18 custom domain data to the browser 2, client or medium.

Referring to again FIG. 43, a method of displaying a customised domain name typically comprises use of a domain registration service 14. The domain registration service 14 is typically provided by one or more computer programs stored in the memory of one or more servers. A domain registration service server may be a dedicated server, or may be a shared server, for example, that runs the domain registration service 14 on a first virtual machine and a web server on a second virtual machine. The domain registration service server may be owned or operated or both by any suitable party such as a browser 2 provider, a search engine provider or an Internet service provider. The domain registration service 14 is arranged such that a URL or domain name manager, administrator or controller can register their domain name and provide custom domain data. Registration of a domain name may require payment of a one-off or recurring fee through a subscription or otherwise.

A user typically accesses a website through a browser 2 on an internet enabled client 4 such as a computer or a mobile phone. In doing so, the user may type a domain name or URL into the location bar or address bar or click on a link such that the browser 2 sends a request 6 for content to a web server 8. The web server 8 receives the request 6 for content and may send the requested content back to the browser 2. The browser 2 may receive 10 the requested content from the web server. In some embodiments, the browser 2 also sends 12 a request for custom domain data to the domain registration service 14, the request comprising at least information indicative of the domain name. URL or domain name. The domain registration service 14 is typically programmed or otherwise configured to receive the request for custom domain data and compare the received domain name or other identifying information with a database 16 of registered domain names which may be stored in memory or remote. The database 16 typically comprises custom domain data which corresponds to the registered domain names. The domain registration service 14 may send 18 the custom domain data corresponding to the domain name information to requesting entity (the browser 2) if there is a match in the database 16. Alternatively, the domain registration service may send 18 a negative response to the browser 2 if there is no match in the database 16. The browser 2 may receive the response from the domain registration service 14 which may comprise custom-domain data if the domain name is registered with the domain registration service 14. Alternatively, the browser 2 may receive a negative response from the domain registration service 14. If the domain name is not registered. The request for custom domain data may be made before, at the same time, or after the request for content.

The custom domain data comprises information which can be read and executed by the browser 2 or client 4 such that the appearance of the contents of the address bar, tab or both may be updated in accordance with the custom domain data, for example, to display one of the domain names or URLs shown in

FIGS. 1 to 3, or FIG. 41. The custom domain data may comprise data, information, or a file pertaining to any suitable combination of digital media such as one or more of a font, a colour, an image, a logo, a trade mark, a favicon, a video, or an animation. The custom domain data may alternatively or additionally comprise a pointer. URL or IP address which directs the browser 2 or client 4 to a location, for example, on the internet from which the additional data or a data stream may be downloaded or otherwise received. In addition to the request for custom domain data, the client 4 or browser 2 may set a value that describes the required response from the domain registration service.

It may be advantageous for the browser 2 to display the received website content only after having received a response, whether positive or negative, from the domain registration service 14. However, the browser 2 may display the received website content at any suitable time. The browser 2 may similarly update the appearance of the contents of the address bar or tab at any suitable time.

If and when the custom domain data is received by the browser 2, the portion of the address bar or tab to be updated may be identified by parsing the full domain name or URL. The font, file, or other information to be displayed may then be applied, for example, only to the domain portion of the URL or to the non-favicon portion of the tab. This may be executed by a scripting language program, such as a JavaScript program. Alternatively, the entire address bar or tab may be updated, In embodiments where the address bar or tab is updated with a custom font, additional processing, such as kerning or letter-spacing, may be required in order to achieve an aesthetically pleasing result as may be desired by a URL or domain name controller or manager. Such additional processing may be executed by a scripting language program such as a JavaScript program.

When the font information is received by the web browser, the font or file may be applied to a specific portion of the URL or other areas described herein. With the URL “http://coca-cola.com/homepage.html” the “coca-cola” portion may be identified in a programming language by parsing the full URL. The font or file to embed may then be applied, for example, only to the domain portion, for example using a scripting language this may look like “applyFont(domainString, font);”. The applyfont method could then use the native method of setting a font to a string, for example in html that may look like “<span style=“font-family:‘coca-cola font’”>coca-cola</span>”. In the case of embedding a file, such as an image file like a JPEG, a way this may look like in software language is “url.setFont(coca-cola)”

With regard to font characters, other methods that achieve the same result may also be employed. For example more control of the rendering of the characters may be required, widths may need to be measured, or kerning applied. In this case the implementation may involve other methods of applying the font to the string. With regard to embedding a file, other methods to achieve this are using JavaScript, such as “new XMLHttpRequest( ).open(‘GET’, ‘font.url’, true)”.

Referring again to FIG. 44, a method of displaying a customised search result may comprise use of the domain registration service 14. A user typically accesses a search engine website through a browser 2 on an internet enabled client 4. The user may enter a search query, for example “coca cola”, into a search box or search field provided on a search engine webpage. The client 4 typically sends 20 a search request to the search engine 22, which may be hosted on one or more search engine servers 24. The search engine 22 receives the search query and generates one or more search results based on the search query, where each search result is typically associated with a domain name. The search engine may execute the search by passing the search query to one or more index servers (which may be incorporated in one or more search engine server 24) which may return a list of relevant search results which may identify one or more websites, domain names or URLs. The search engine server 24 may send 6 a request content or other data from the identified websites which are each typically hosted on a web server 8. The one or more web servers 8 may send the requested content back to the one or more search engine server 24. The content may be received 10 at the search engine server 24.

The search engine server 24 may send 12 a request for custom domain data to the domain registration service 14. The request for custom domain data may comprise information indicative of the domain name associated with each search result identified previously. The domain registration service 14 may receive the request and compare the received domain name information with a database 16 of registered domain names. The domain registration service 14 may send 18 the custom domain data corresponding to the domain name information back to the requesting entity (the search engine server 24) if there is one or more matches in the database 16. Alternatively, the domain registration service may send 18 a negative response to the search engine server 24 if there is no match in the database 16. The search engine server 24 may receive the custom domain data from the domain registration service 14 if one or more of the domain names associated with the search results are registered with the domain registration service 14, the custom domain data corresponding to the one or more registered domain names. The search engine server 24 may update each of the search results for which custom domain data was received in accordance with the custom domain data, and sends 28 the updated search results to the browser 2 for display to a user. The search results may be displayed on the browser 2 such that any search results corresponding to registered, domains are customised.

The custom domain data comprises information which can be read and executed by the search engine server 24 so that customised search results may be displayed if there is a search result corresponding to a registered domain. The custom domain data may comprise data, information, or a file pertaining to any suitable combination of digital media such as one or more of a font, a colour, an image, a logo, a trade mark, a favicon, a video, or an animation. The custom domain data may alternatively or additionally comprise a pointer, URL or IP address which directs the client 4 or browser 2 to a location, for example on the Internet, from which the additional data or a data stream may be downloaded or otherwise received. In addition to the request 12 for custom domain data, the search engine server 24 may set a value that describes the required response from the domain registration service.

It may be advantageous for the search engine server 24 to send 28 the search results to the client only after having received a response, whether positive or negative, from the domain registration service 14. However, in some embodiments, the search engine server 24 may send 28 the search results before sending 28 the custom domain data. In such embodiments, the client 4 or browser 2 may be arranged to update the displayed search results with custom search results when the custom domain data is received.

If and when the custom domain data is received by the search engine server 24, the portion of the search results to be updated may be identified by parsing the search results. The font, file, or other information to be displayed may then be applied, for example, only to the search results with corresponding custom domain data.

The domain registration service 14 may comprise an API arranged to allow the browser 2 or search engine server 24 to request information indicating whether or not a domain name or URL has been registered by using, for example, a key-value pair such as <domain, custom domain data>. It may be advantageous to use a key-value, scalable database such as a Redis database, although any appropriate database may be used.

In some embodiments, a URL or domain name controller may be required to prove ownership of a domain, for example, when registering the domain with the domain registration service. Ownership or control may be proven by adding a program or appropriate code, such as a JavaScript program or code, into the website source code, the program or code being arranged to verify ownership of the domain. Verification of ownership of a domain may be executed in any suitable manner.

Any font may be substituted at least in part, or in full, with use of a file, such as a jpeg, gif, animation file such as flash, or any other suitable file. Such a file, or files could be embedded into the URL in part, or in full, creating the URL, or any search results. In the case of coca cola for example, as shown for example in FIG. 41, at 30, the trade mark name coca cola could be an embedded image file and or individual font characters. This could also appear as an embedded file in the browser area. Such embedded files could be anywhere on screen or visible as described in this document, and may or may not be interactive, and may provide information on promotions, or pop-up information. A user may be able to close such pop-up information

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In the claims which follow and in the preceding description of the invention, except where the context requires otherwise due to express language or necessary implication, the term “click” or variations such as “clicks” includes the term “double click” or suitable other GUI manipulation functions such as rolling a cursor, or sliding a finger on a touchscreen.

It is to be understood that, if any prior art publication is referred to herein, such reference does not constitute an admission that the publication forms a part of the common general knowledge in the art in any country.

1. A method of displaying a customiszed location bar or tab in a browser comprising:
sending a request for content from a browser to a web server associated with a uniform resource locator (URL) entered into the browser;
receiving the requested content from the web server at the browser;
sending a request for custom domain data from the browser to a domain registration service, the request for custom domain data comprising information indicative of at least a portion of the URL;
receiving custom domain data from the domain registration service at the browser if at least a portion of the URL is registered with the domain registration service, wherein the custom domain data relates to a desired appearance of the location bar or tab and can be used by the browser to update the appearance of the location bar or tab; and
updating the appearance of the contents of the location bar or tab in accordance with the received custom domain data.

2. The method according to claim 1, wherein the information indicative of the URL is a domain name and custom domain data is received if the domain name is registered with the domain registration service.

3. The method according to claim 1, wherein the received custom domain data comprises different items of custom domain data corresponding to the same domain name, and where the browser updates the appearance of the contents of the location bar or tab according to the custom domain data corresponding with the displayed URL.

4. The method according to claim 1 comprising receiving a negative response from the domain registration service at the browser if the URL is not registered with the domain registration service.

5. The method according to claim 1 comprising displaying the requested content in the browser after receiving the custom domain data at the browser.

6. The method according to claim 1 comprising displaying an interface in the browser that is arranged to allow a website manager to modify the updated appearance of the location bar or tab.

7. A method of displaying a customiszed search result from a search engine comprising:
sending a search query from a browser to a search engine;
receiving the search query at the search engine and generating information indicative of one or more search results based on the search query where each search result is associated with a uniform resource locator (URL);
sending a request for custom domain data from the search engine to a domain registration service, the request for custom domain data comprising information indicative of at least a portion of each of the one or more URLs;
receiving custom domain data from the domain registration service at the search engine for each URL registered with the domain registration service, wherein each custom domain data entry relates to a desired appearance of its corresponding search result and can be used by the browser to update the appearance of the one or more search results;
receiving the information indicative of the one or more search results and the custom domain data from the search engine at the web browser; and
displaying the search results in the browser such that the appearance of each search result with corresponding custom domain data is updated in accordance with the custom domain data.

8. The method according to claim 7, wherein the information indicative of the URL is a domain name and custom domain data is received if the domain name is registered with the domain registration service.

9. The method according to claim 7, wherein the received custom domain data comprises different items of custom domain data corresponding to the same domain name, and where the browser controls the appearance of the search results according to the custom domain data corresponding with the URL of the displayed search result.

10. The method according to claim 7, wherein the search engine is arranged to send a request for content to a web server, receive content from the web server, and send the content to the browser.

11. The method according to claim 7 comprising receiving a negative response from the domain registration service at the search engine if none of the URLs are registered with the registration service.

12. The method according to claim 7 comprising displaying an interface in the browser that is arranged to allow a website manager to modify the updated appearance of a search result.

13.-14. (canceled)

15. A domain registration service comprising:
a database of custom domain data indexed by at least portions of uniform resource locators (URLs), wherein each custom domain data entry relates to a desired appearance of a location bar, tab or one or more search results and can be used by a browser to update the appearance of the location bar, tab or one or more search results, and wherein for at least some of the URLs the database of custom domain data comprises different items of custom domain data;
the domain registration service being arranged to receive a request for custom domain data from a requesting entity comprising information indicative of at least a portion of a URL, search the database of custom domain data based on the received information indicative of a URL, and send any located custom domain data to the requesting entity,
whereby the domain registration service returns different custom domain data related to the same domain name depending on the URL of the request.

16. The domain registration service as claimed in claim 15, wherein the at least a portion of a URL comprises a domain name.

17. The domain registration service as claimed in claim 15, wherein the request for custom domain data comprises the URL, and where the domain registration service is arranged to extract at least one portion from the URL to search the database.

18. A computer-based system comprising:
a domain registration service;
a browser comprising a location bar or a tab and being arranged to send a request for content to and receive content from a web server associated with a uniform resource locator (URL), send a request for custom domain data comprising information indicative of at least a portion of the URL to a domain registration service, receive custom domain data from the domain registration service, display content received from the web server, and update the appearance of the location bar or tab in accordance with the custom domain data from the domain registration service; the domain registration service comprising a database of custom domain data indexed by at least a portion of a URL, wherein each custom domain data entry relates to a desired appearance of the location bar or tab, and wherein the domain registration service is arranged to receive from the browser a request for custom domain data comprising information indicative of at least a portion of a URL, search the database of custom domain data based on the received information indicative of a URL, and send to the browser any located custom domain data such that the browser can update the appearance of the location bar or tab.

19. The computer-based system according to claim 18 comprising a web server associated with a URL and being arranged to host content associated with a website associated with the URL, and to receive the request for content from and send content to the browser.

20. The computer-based system according to claim 18, wherein the information indicative of the URL is a domain name and custom domain data is received if the domain name is registered with the domain registration service.

21. The computer-based system according to claim 18, wherein the received custom domain data comprises different items of custom domain data corresponding to the same domain name, and where the browser updates the appearance of the contents of the location bar or tab according to the custom domain data corresponding with the displayed URL.

22. The computer-based system according to claim 18, wherein the domain registration service is arranged to send a negative response to the browser if the URL is not registered with the domain registration service.

23. The computer-based system according to claim 18 arranged to display the requested content in the browser after receiving the custom domain data at the browser.

24. The computer-based system according to claim 18, wherein the browser is arranged to display an interface arranged to allow a website manager to modify the updated appearance of the location bar.

25.-33. (canceled)
